(19) United States
(12) Patent Application Publication
(10) Pub. No.: US 2022/0334362 A1
(43) Pub. Date: Oct. 20, 2022

(54) Optical Imaging System

(71) Applicant: ZHEJIANG SUNNY OPTICS CO.,LTD., Ningbo (CN)

(72) Inventors: Jian ZHANG, Ningbo (CN); Yabin HU, Ningbo (CN); Jianke WENREN, Ningbo (CN); Fujian DAI, Ningbo (CN); Liefeng ZHAO, Ningbo (CN)

(21) Appl. No.: 17/718,352

(22) Filed: Apr. 12, 2022

(30) Foreign Application Priority Data
Apr. 13, 2021 (CN) 202110392883.5

(51) Int. Cl. G02B 13/00; G02B 9/64; G02B 3/04

(52) U.S. Cl. CPC G02B 13/0045; G02B 9/64; G02B 3/04; G02B 13/02

(57) ABSTRACT

The disclosure provides an optical imaging system, which sequentially includes from an object side to an image side along an optical axis: a diaphragm; a first lens with a refractive power; a second lens with a negative refractive power; a third lens with a refractive power; a fourth lens with a negative refractive power; a fifth lens with a refractive power; a sixth lens with a positive refractive power, an image-side surface thereof is a convex surface; and a seventh lens with a refractive power, wherein an effective focal length f of the optical imaging system and an entrance pupil diameter (EPD) of the optical imaging system satisfy: f/EPD<1.4; the effective focal length f of the optical imaging system and a curvature radius R4 of an image-side surface of the second lens satisfy: 2.5<f/R≤3.5.

### CROSS-REFERENCE TO RELATED PRESENT INVENTIONS

The disclosure claims priority to and the benefit of Chinese Patent Present invention No. 202110392883.5, filed in the China National Intellectual Property Administration (CNIPA) on 13 Apr. 2021, which is incorporated herein by reference in its entirety.

### TECHNICAL FIELD

The disclosure relates to the technical field of the optical imaging, and particularly relates to an optical imaging system including seven lenses.

### BACKGROUND

With the rapid development of smart phones, requirements for mobile phone camera lenses with high imaging performance, particularly people's requirements for taking clear portraits, have increased. In order to provide better photographing experiences for users, a mobile phone camera lens needs to have the characteristics of subject focusing and background defocusing. This needs an optical imaging lens with a large aperture and a large focal length.

Therefore, there is a need for a seven-lens telephoto lens using aspheric surfaces, which is high in imaging quality and suitable for taking clear portraits.

### SUMMARY

The disclosure is intended to provide an optical imaging system including seven lenses, which has a large aperture and a large focal length and is high in imaging quality and suitable for taking clear portraits.

An embodiment of the disclosure provides an optical imaging system, which sequentially includes from an object side to an image side along an optical axis: a diaphragm; a first lens with a refractive power; a second lens with a negative refractive power; a third lens with a refractive power; a fourth lens with a negative refractive power; a fifth lens with a refractive power; a sixth lens with a positive refractive power, an image-side surface thereof is a convex surface; and a seventh lens with a refractive power;

wherein an effective focal length f of the optical imaging system and an entrance pupil diameter (EPD) of the optical imaging system satisfy: f/EPD<1.4.

In an implementation mode, an effective focal length f1 of the first lens, a curvature radius R1 of an object-side surface of the first lens and the effective focal length f of the optical imaging system satisfy: 1.0<(f1+R1)/f<1.6.

In an implementation mode, an effective focal length f2 of the second lens and a curvature radius R3 of an object-side surface of the second lens satisfy: −6.5<f2/R3<−2.0.

In an implementation mode, the effective focal length f of the optical imaging system and a curvature radius R4 of an image-side surface of the second lens satisfy: 2.5<f/R4≤3.5.

In an implementation mode, an effective focal length f3 of the third lens and a curvature radius R5 of an object-side surface of the third lens satisfy: 1.5<f3/R5<5.0.

In an implementation mode, an effective focal length f4 of the fourth lens, a curvature radius R8 of an image-side surface of the fourth lens and the effective focal length f of the optical imaging system satisfy: −3.0<(f4+R8)/f<0.

In an implementation mode, an effective focal length f6 of the sixth lens and a curvature radius R12 of the image-side surface of the sixth lens satisfy: −2.0<f6/R12<0.

In an implementation mode, an effective focal length f7 of the seventh lens and a curvature radius R14 of an image-side surface of the seventh lens satisfy: −9.5<f7/R14<−2.5.

In an implementation mode, a center thickness CT1 of the first lens on the optical axis and a center thickness CT2 of the second lens on the optical axis satisfy: 3.5<CT1/CT2<5.0.

In an implementation mode, a center thickness CT3 of the third lens on the optical axis and a center thickness CT5 of the fifth lens on the optical axis satisfy: 2.0<CT3/CT5<3.5.

In an implementation mode, T45 is an air space between the fourth lens and the fifth lens on the optical axis, T34 is an air space between the third lens and the fourth lens on the optical axis, and T45 and T34 satisfy: 17.0 mm⁻²<1/(T45×T34)<27.0 mm⁻².

In an implementation mode, Semi-FOV is a half of a maximum field of view of the optical imaging system, and Semi-FOV satisfies: 10.0°<Semi-FOV<30.0°.

In an implementation mode, TTL is an on-axis distance from an object-side surface of the first lens to an imaging surface, ImgH is a half of a diagonal length of an effective pixel region on the imaging surface, and TTL and ImgH satisfy: 2.5<TTL/ImgH<3.0.

Another embodiment of the disclosure provides an optical imaging system, which sequentially includes from an object side to an image side along an optical axis: a diaphragm; a first lens with a refractive power; a second lens with a negative refractive power; a third lens with a refractive power; a fourth lens with a negative refractive power; a fifth lens with a refractive power; a sixth lens with a positive refractive power, an image-side surface thereof is a convex surface; and a seventh lens with a refractive power;

wherein the lenses are independent of each another; there are air spaces between each of the lenses on the optical axis; and an effective focal length f of the optical imaging system and a curvature radius R4 of an image-side surface of the second lens satisfy: 2.5<f/R4≤3.5.

The disclosure has the following beneficial effects.

The optical imaging system provided in the disclosure includes multiple lenses, e.g., the first lens to the seventh lens. The optical imaging system of the disclosure has a large aperture and a large focal length, and is high in imaging quality and suitable for taking clear portraits.

### BRIEF DESCRIPTION OF THE DRAWINGS

In order to describe the technical solutions in the embodiments of the disclosure more clearly, the drawings required to be used for describing the embodiments will be simply introduced below. It is apparent that the drawings described below are only some embodiments of the disclosure. Those of ordinary skill in the art may further obtain other drawings according to these drawings without creative work.

FIG. 1 shows a structural schematic diagram of a lens group of an optical imaging system according to Embodiment 1 of the disclosure;

FIGS. 2a-2d show a longitudinal aberration curve, an astigmatism curve, a distortion curve and a lateral color curve of an optical imaging system according to Embodiment 1 of the disclosure respectively;

FIG. 3 shows a structural schematic diagram of a lens group of an optical imaging system according to Embodiment 2 of the disclosure;

FIGS. 4a-4d show a longitudinal aberration curve, an astigmatism curve, a distortion curve and a lateral color curve of an optical imaging system according to Embodiment 2 of the disclosure respectively;

FIG. 5 shows a structural schematic diagram of a lens group of an optical imaging system according to Embodiment 3 of the disclosure;

FIGS. 6a-6d show a longitudinal aberration curve, an astigmatism curve, a distortion curve and a lateral color curve of an optical imaging system according to Embodiment 3 of the disclosure respectively;

FIG. 7 shows a structural schematic diagram of a lens group of an optical imaging system according to Embodiment 4 of the disclosure;

FIGS. 8a-8d show a longitudinal aberration curve, an astigmatism curve, a distortion curve and a lateral color curve of an optical imaging system according to Embodiment 4 of the disclosure respectively;

FIG. 9 shows a structural schematic diagram of a lens group of an optical imaging system according to Embodiment 5 of the disclosure;

FIGS. 10a-10d show a longitudinal aberration curve, an astigmatism curve, a distortion curve and a lateral color curve of an optical imaging system according to Embodiment 5 of the disclosure respectively;

FIG. 11 shows a structural schematic diagram of a lens group of an optical imaging system according to Embodiment 6 of the disclosure; and

FIGS. 12a-12d show a longitudinal aberration curve, an astigmatism curve, a distortion curve and a lateral color curve of an optical imaging system according to Embodiment 6 of the disclosure respectively.

### DETAILED DESCRIPTION OF THE EMBODIMENTS

The technical solutions in embodiments of the disclosure will be described clearly and completely below in combination with the drawings in the embodiments of the disclosure. It is apparent that the described embodiments are not all but only part of embodiments of the disclosure. All other embodiments obtained by those of ordinary skill in the art based on the embodiments in the disclosure without creative work shall fall within the scope of protection of the disclosure.

It should be noted that, in this description, expressions first, second, third and the like are only used to distinguish one feature from another feature and do not represent any limitation to the feature. Thus, a first lens discussed below may also be referred to as a second lens or a third lens without departing from the teachings of the disclosure.

It should also be understood that terms “include”, “including”, “have”, “contain”, and/or “containing”, used in the specification, represent existence of a stated feature, component and/or part but do not exclude existence or addition of one or more other features, components and parts and/or combinations thereof. In addition, expressions like “at least one in . . . ” may appear after a list of listed features not to modify an individual component in the list but to modify the listed features. Moreover, when the implementation modes of the disclosure are described, “may” is used to represent “one or more implementation modes of the disclosure”. Furthermore, term “exemplary” refers to an example or exemplary description.

In the drawings, the thickness, size and shape of the lens have been slightly exaggerated for ease illustration. In particular, a spherical shape or aspheric shape shown in the drawings is shown by some embodiments. That is, the spherical shape or the aspheric shape is not limited to the spherical shape or aspheric shape shown in the drawings. The drawings are by way of example only and not strictly to scale.

In the description of the disclosure, a paraxial region refers to a region nearby an optical axis. If a surface of a lens is a convex surface and a position of the convex surface is not defined, it indicates that at least a paraxial region of the surface of the lens is a convex surface. If a surface of a lens is a concave surface and a position of the concave surface is not defined, it indicates that at least a paraxial region of the surface of the lens is a concave surface. A surface, closest to a shot object, of each lens is called an object-side surface of the lens, and a surface, closest to an imaging surface, of each lens is called an image-side surface of the lens.

Unless otherwise defined, all terms (including technical terms and scientific terms) used in the disclosure have the same meanings as commonly understood by those of ordinary skill in the art of the disclosure. It should also be understood that the terms (for example, terms defined in a common dictionary) should be explained to have meanings consistent with the meanings in the context of a related art and may not be explained with ideal or excessively formal meanings, unless clearly defined like this in the disclosure.

It is to be noted that the embodiments in the disclosure and features in the embodiments may be combined without conflicts. The features, principles and other aspects of the disclosure will be described in detail below with reference to the drawings and in combination with embodiments.

### Exemplary Embodiments

An optical imaging system of the exemplary embodiment of the disclosure includes seven lenses, sequentially including from an object side to an image side along an optical axis: a diaphragm, a first lens, a second lens, a third lens, a fourth lens, a fifth lens, a sixth lens and a seventh lens. The lenses are independent of each another. There are air spaces between each of the lenses on the optical axis.

In an exemplary embodiment, the first lens may have a positive refractive power or a negative refractive power; the second lens has a negative refractive power; the third lens may have a positive refractive power or a negative refractive power; the fourth lens has a negative refractive power; the fifth lens may have a positive refractive power or a negative refractive power; the sixth lens has a positive refractive power, and an image-side surface thereof is a convex surface; and the seventh lens may have a positive refractive power or a negative refractive power.

In an exemplary embodiment, an effective focal length f of the optical imaging system and an entrance pupil diameter (EPD) of the optical imaging system satisfy a conditional expression: f/EPD<1.4. The refractive powers of the lenses are configured reasonably, so that the optical imaging system may have a small aberration; a ratio of the focal length to the entrance pupil diameter is restricted, so that a luminous flux of the optical imaging system may be increased, an imaging effect in a dark environment is improved, and meanwhile, an aberration in a marginal field of view may be reduced. More specifically, f and EPD satisfy: 1.2<f/EPD<1.3, e.g., 1.22≤f/EPD≤1.27.

In an exemplary embodiment, an effective focal length f1 of the first lens, a curvature radius R1 of an object-side surface of the first lens and an effective focal length f of the optical imaging system satisfy a conditional expression: 1.0<(f1+R1)/f<1.6. The effective focal length of the first lens, the effective focal length of the optical imaging system and the curvature radius of the object-side surface of the first lens are restricted, so that a light converging capability may be improved, and a reduction of an aberration of the optical imaging system is facilitated. More specifically, f1, R1 and f satisfy: 1.3<(f1+R1)/f<1.55, e.g., 1.31≤(f1+R1)/f≤1.53.

In an exemplary embodiment, an effective focal length f2 of the second lens and a curvature radius R3 of an object-side surface of the second lens satisfy a conditional expression: −6.5≤f2/R3<−2.0. The effective focal length of the second lens and the curvature radius of the object-side surface of the second lens are restricted, so that a deflection angle of light at the second lens may be controlled, which contributes to reducing a sensitivity of the optical imaging system. More specifically, f2 and R3 satisfy: −6.4<f2/R3<−2.1, e.g., −6.33≤f2/R3≤−2.13.

In an exemplary embodiment, an effective focal length f of the optical imaging system and a curvature radius R4 of an image-side surface of the second lens satisfy a conditional expression: 2.5<f/R4≤3.5. A ratio of the effective focal length of the optical imaging system to the curvature radius of the image-side surface of the second lens is restricted to help to correct an aberration so as to endow the lens with high imaging quality. More specifically, f and R4 satisfy: 2.7<f/R4␣3.5, e.g., 2.75≤f/R4≤3.50.

In an exemplary embodiment, an effective focal length f3 of the third lens and a curvature radius R5 of an object-side surface of the third lens satisfy a conditional expression: 1.5␣f3/R5<5.0. The effective focal length of the third lens and the curvature radius of the object-side surface of the third lens are restricted, so that the optical imaging lens is endowed with a relatively high capability in balancing chromatic aberrations and distortions. More specifically, f3 and R5 satisfy: 1.6<f3/R5<4.6, e.g., 1.68≤f3/R5≤4.53.

In an exemplary embodiment, an effective focal length f4 of the fourth lens, a curvature radius R8 of an image-side surface of the fourth lens and an effective focal length f of the optical imaging system satisfy a conditional expression: −3.0<(f4+R8)/f<0. The effective focal length of the fourth lens, the effective focal length of the optical imaging system and the curvature radius of the image-side surface of the fourth lens are controlled reasonably, so that the optical imaging system may have a small spherical aberration, and the lens is high in imaging quality. More specifically, f4, R8 and f satisfy: −2.9<(f4+R8)/f<−0.1, e.g., −2.875≤(f4+R8)/f≤−0.18.

In an exemplary embodiment, an effective focal length f6 of the sixth lens and a curvature radius R12 of the image-side surface of the sixth lens satisfy a conditional expression: −2.0≤f6/R12<0. The effective focal length of the sixth lens and the curvature radius of the image-side surface of the sixth lens are restricted, so that a deflection angle of light at the sixth lens may be controlled effectively, and the system is high in machinability. More specifically, f6 and R12 satisfy: −1.9<f6/R12<−1, e.g., −1.89≤f6/R12≤−1.11.

In an exemplary embodiment, an effective focal length f7 of the seventh lens and a curvature radius R14 of an image-side surface of the seventh lens satisfy a conditional expression: −9.5<f7/R14<−2.5. The effective focal length of the seventh lens and the curvature radius of the image-side surface of the seventh lens are restricted, so that an angle of light in a marginal field of view may be controlled in a reasonable range, and a sensitivity of the optical imaging system may be reduced effectively. More specifically, f7 and R14 satisfy: −5<f7/R14<−2.7, e.g., −4.95≤f7/R14≤−2.77.

In an exemplary embodiment, a center thickness CT1 of the first lens on the optical axis and a center thickness CT2 of the second lens on the optical axis satisfy a conditional expression: 3.5<CT1/CT2<5.0. A ratio of the center thicknesses of the first lens and the second lens on the optical axis is controlled reasonably, so that a varying degree of freedom of the lens surface is increased to further improve a capability of the optical imaging system in correcting astigmatisms and field curvatures. More specifically, CT1 and CT2 satisfy: 3.7<CT1/CT2<4.5, e.g., 3.78≤CT1/CT2≤4.34.

In an exemplary embodiment, a center thickness CT3 of the third lens on the optical axis and a center thickness CT5 of the fifth lens on the optical axis satisfy a conditional expression: 2.0<CT3/CT5<3.5. A ratio of the center thicknesses of the third lens and the fifth lens on the optical axis is controlled reasonably, so that a size of the optical imaging system is reduced effectively to avoid a too large lens group of the optical imaging system. More specifically, CT3 and CT5 satisfy: 2.5<CT3/CT5<3.1, e.g., 2.59≤CT3/CT5≤3.03.

In an exemplary embodiment, T45 is an air space between the fourth lens and the fifth lens on the optical axis, T34 is an air space between the third lens and the fourth lens on the optical axis, and T45 and T34 satisfy a conditional expression: 17.0 mm⁻²<1/(T45×T34)<27.0 mm⁻². A ratio of the air space between the third lens and the fourth lens on the optical axis to the air space between the fourth lens and the fifth lens on the optical axis is controlled reasonably to help to control a distortion of the system so as to ensure high distortion performance of the optical imaging system. More specifically, T45 and T34 satisfy 17.1 mm²<1/(T45×T34)<26.95 mm⁻², e.g., 17.20 mm⁻²≤1/(T45×T34)≤26.94 mm⁻².

In an exemplary embodiment, Semi-FOV is a half of a maximum field of view of the optical imaging system, and Semi-FOV satisfies a conditional expression: 10.0°<Semi-FOV<30.0°. The half of the maximum field of view of the optical imaging lens is controlled reasonably, so that the optical imaging system satisfies a characteristic of large focal length and has a relatively capability in balancing aberrations, a deflection angle of a chief ray may be controlled reasonably, and a matching degree with a chip is improved. More specifically, Semi-FOV satisfies: 20°<Semi-FOV<22°, e.g., 20.3°≤Semi-FOV≤21.3°.

In an exemplary embodiment, TTL is an on-axis distance from an object-side surface of the first lens to an imaging surface, ImgH is a half of a diagonal length of an effective pixel region on the imaging surface, and TTL and ImgH satisfy a conditional expression: 2.5<TTL/ImgH<3.0. A ratio of a total length of the optical imaging system to an image height is restricted reasonably to facilitate a miniaturization of the optical imaging lens. More specifically, TTL and ImgH satisfy: 2.7<TTL/ImgH<3.0, e.g., 2.805≤TTL/ImgH≤2.99.

In an exemplary embodiment, the optical imaging system may further include a diaphragm. The diaphragm may be arranged at an appropriate position as required. For example, the diaphragm may be arranged between the object side and the first lens. In an embodiment, the optical imaging system may further include an optical filter configured to correct a chromatic aberration and/or a protective glass configured to protect a photosensitive element on the imaging surface.

The optical imaging system according to the embodiment of the disclosure may adopt multiple lenses, for example, the above-mentioned seven. The refractive powers and surface types of each lens, the center thickness of each lens, on-axis distances between the lenses and the like are configured reasonably to endow the optical imaging system with a relatively large imaging surface and the characteristics of wide imaging range and high imaging quality and ensure an ultra-thin design of a mobile phone.

In an exemplary embodiment, at least one of mirror surfaces of each lens is an aspheric mirror surface. That is, at least one mirror surface in the object-side surface of the first lens to the image-side surface of the seventh lens is an aspheric mirror surface. An aspheric lens has such a characteristic that a curvature keeps changing from a center of the lens to a periphery of the lens. Unlike a spherical lens with a constant curvature from a center of the lens to a periphery of the lens, the aspheric lens has a better curvature radius characteristic and the advantages of improving distortions and improving astigmatic aberrations. With the adoption of the aspheric lens, astigmatism aberrations during imaging may be eliminated as much as possible, thereby improving the imaging quality. In an embodiment, at least one of the object-side surface and the image-side surface of each lens in the first lens, the second lens, the third lens, the fourth lens, the fifth lens, the sixth lens and the seventh lens is an aspheric mirror surface. In another embodiment, both the object-side surface and the image-side surface of each lens in the first lens, the second lens, the third lens, the fourth lens, the fifth lens, the sixth lens and the seventh lens are aspheric mirror surfaces.

However, those skilled in the art should know that the number of the lenses forming the optical imaging system may be changed without departing from the technical solutions claimed in the disclosure to achieve each result and advantage described in the specification. For example, although descriptions are made in the embodiment with seven lenses as an example, the optical imaging system is not limited to seven lenses. If necessary, the optical imaging system may include another number of lenses.

Specific embodiments applicable to the optical imaging system of the above-mentioned embodiment will further be described below with reference to the drawings.

### Embodiment 1

FIG. 1 shows a structural schematic diagram of a lens group of an optical imaging system according to Embodiment 1 of the disclosure. The optical imaging system sequentially includes from an object side to an image side along an optical axis: a diaphragm STO, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, and an image-side surface S2 thereof is a concave surface. The second lens E2 has a negative refractive power, an object-side surface S3 thereof is a convex surface, and an image-side surface S4 thereof is a concave surface. The third lens E3 has a positive refractive power, an object-side surface S5 thereof is a convex surface, and an image-side surface S6 thereof is a concave surface. The fourth lens E4 has a negative refractive power, an object-side surface S7 thereof is a convex surface, and an image-side surface S8 thereof is a concave surface. The fifth lens E5 has a positive refractive power, an object-side surface S9 thereof is a convex surface, and an image-side surface S10 thereof is a concave surface. The sixth lens E6 has a positive refractive power, an object-side surface S11 thereof is a convex surface, and an image-side surface S12 thereof is a convex surface. The seventh lens E7 has a negative refractive power, an object-side surface S13 thereof is a convex surface, and an image-side surface S14 thereof is a concave surface. The optical filter E8 has an object-side surface S15 and an image-side surface S16. Light from an object sequentially penetrates through each of the surfaces S1 to S16, and is finally imaged on the imaging surface S17.

Table 1 shows a basic parameter table of the optical imaging system of Embodiment 1, wherein units of the curvature radius, the thickness and the focal length are all millimeters (mm).

TABLE 1

| Surface | Surface | Curvature | Thickness/ | Focal | Refractive | Abbe | Conic |
|---|---|---|---|---|---|---|---|
| number | type | radius | distance | length | index | number | coefficient |
| OBJ | Spherical | Infinite | Infinite | | | | |
| STO | Spherical | Infinite | −1.5000 | | | | |
| S1 | Aspheric | 3.8729 | 2.0833 | 7.69 | 1.55 | 56.1 | −1.0194 |
| S2 | Aspheric | 40.5971 | 0.1000 | | | | −0.0370 |
| S3 | Aspheric | 4.1500 | 0.4800 | −10.08 | 1.68 | 19.2 | 0.0017 |
| S4 | Aspheric | 2.4602 | 0.1569 | | | | −1.0425 |
| S5 | Aspheric | 3.2752 | 1.4033 | 13.86 | 1.55 | 56.1 | −0.0044 |
| S6 | Aspheric | 4.8998 | 0.0993 | | | | −0.0497 |
| S7 | Aspheric | 4.8238 | 0.4800 | −28.40 | 1.68 | 19.2 | 0.1275 |
| S8 | Aspheric | 3.7012 | 0.5692 | | | | 0.1233 |
| S9 | Aspheric | 4.3808 | 0.4800 | 174.97 | 1.68 | 19.2 | 0.2166 |
| S10 | Aspheric | 4.3478 | 0.7636 | | | | 0.2557 |
| S11 | Aspheric | 1465.8210 | 0.8825 | 19.79 | 1.68 | 19.2 | −99.0000 |
| S12 | Aspheric | −13.5144 | 0.6216 | | | | 23.9047 |
| S13 | Aspheric | 12.3878 | 0.4800 | −10.71 | 1.54 | 55.7 | −69.0042 |
| S14 | Aspheric | 3.8718 | 0.1004 | | | | −0.2627 |
| S15 | Spherical | Infinite | 0.2100 | | 1.52 | 64.2 | |
| S16 | Spherical | Infinite | 0.5900 | | | | |
| S17 | Spherical | Infinite | | | | | |

As shown in Table 2, in Embodiment 1, f is a total effective focal length of the optical imaging system, and f is 8.60 mm. TTL is a distance from the object-side surface S1 of the first lens E1 to the imaging surface S17 on the optical axis, and TTL is 9.50 mm. ImgH is a half of a diagonal length of an effective pixel region on the imaging surface S17, and ImgH is 3.39 mm. Semi-FOV is a half of a maximum field of view of the optical imaging system, and Semi-FOV is 20.6°.

TABLE 2
Embodiment 1

| | | | |
|---|---|---|---|
| f(mm) | 8.60 | TTL(mm) | 9.50 |
| ImgH(mm) | 3.39 | Semi-FOV(°) | 20.6 |
| f/EPD | 1.23 | (f1 + R1)/f | 1.34 |
| f2/R3 | −2.43 | f/R4 | 3.50 |
| f3/R5 | 4.23 | (f4 + R8)/f | −2.87 |
| f6/R12 | −1.46 | f7/R14 | −2.77 |
| CT1/CT2 | 4.34 | CT3/CT5 | 2.92 |
| 1/(T45 × T34)(mm⁻²) | 17.69 | TTL/ImgH | 2.80 |

The optical imaging system in Embodiment 1 satisfies:

f/EPD=1.23, wherein f is the effective focal length of the optical imaging system, and EPD is an entrance pupil diameter of the optical imaging system;

(f1+R1)/f=1.34, wherein f1 is an effective focal length of the first lens, R1 is a curvature radius of the object-side surface of the first lens, and f is the effective focal length of the optical imaging system;

f2/R3=−2.43, wherein f2 is an effective focal length of the second lens, and R3 is a curvature radius of the object-side surface of the second lens;

f/R4=3.50, wherein f is the effective focal length of the optical imaging system, and R4 is a curvature radius of the image-side surface of the second lens;

f3/R5=4.23, wherein f3 is an effective focal length of the third lens, and R5 is a curvature radius of the object-side surface of the third lens;

(f4+R8)/f=−2.87, wherein f4 is an effective focal length of the fourth lens, R8 is a curvature radius of the image-side surface of the fourth lens, and f is the effective focal length of the optical imaging system;

f6/R12=−1.46, wherein f6 is an effective focal length of the sixth lens, and R12 is a curvature radius of the image-side surface of the sixth lens;

f7/R14=−2.77, wherein f7 is an effective focal length of the seventh lens, and R14 is a curvature radius of the image-side surface of the seventh lens;

CT1/CT2=4.34, where CT1 is a center thickness of the first lens on the optical axis, and CT2 is a center thickness of the second lens on the optical axis;

CT3/CT5=2.92, wherein CT3 is a center thickness of the third lens on the optical axis, and CT5 is a center thickness of the fifth lens on the optical axis;

1/(T45×T34)=17.69 mm⁻², wherein T45 is an air space between the fourth lens and the fifth lens on the optical axis, and T34 is an air space between the third lens and the fourth lens on the optical axis;

Semi-FOV=20.6°, wherein Semi-FOV is the half of the maximum field of view of the optical imaging system; and

TTL/ImgH=2.80, wherein TTL is the distance from the object-side surface of the first lens to the imaging surface on the optical axis, and ImgH is the half of the diagonal length of the effective pixel region on the imaging surface.

In Embodiment 1, both the object-side surface and the image-side surface of any lens in the first lens E1 to the seventh lens E7 are, aspheric surfaces. A surface type x of each aspheric lens may be defined through, but not limited to, the following aspheric surface formula:

$$x = \frac{{ch}^{2}}{1 + \sqrt{1 - ( k + 1 ) {c}^{2} {h}^{2}}} + \sum {Aih}^{i} , \qquad ( I )$$

wherein x is a vector height of a distance between the aspheric surface and a vertex of the aspheric surface when the aspheric surface is located at a position with the height h in the optical axis direction; c is a paraxial curvature of the aspheric surface, c=1/R (namely, the paraxial curvature c is a reciprocal of the curvature radius R in Table 1); k is a conic coefficient; and Ai is a correction coefficient of the i-th order of the aspheric surface.

In Embodiment 1, both the object-side surface and the image-side surface of any lens in the first lens E1 to the seventh lens E7 are aspheric surfaces. Table 3 shows high-order coefficients A4, A6, A8, A10, A12, A14, A16, A18, A20, A22, A24, A26, A28 and A30 that may be used for each of the aspheric mirror surfaces S1 to S14 in Embodiment 1.

TABLE 3

| Surface | | | | | | | |
|---|---|---|---|---|---|---|---|
| number | A4 | A6 | A8 | A10 | A12 | A14 | A16 |
| S1 | 2.7313E−01 | 1.3924E−02 | −6.9798E−04 | −2.0495E−03 | −1.0159E−03 | −8.7140E−04 | −2.7264E−04 |
| S2 | 1.4986E−01 | −1.3083E−02 | 1.0912E−03 | −3.0562E−03 | −1.0568E−03 | −7.4243E−05 | −1.3774E−04 |
| S3 | −2.4520E−01 | −8.0467E−04 | 8.5581E−03 | −2.1604E−03 | −2.0733E−03 | −5.2782E−04 | 1.6147E−04 |
| S4 | 1.0756E−01 | 1.3156E−02 | 5.9038E−03 | −8.0442E−04 | −1.1175E−03 | −1.6006E−03 | 1.8635E−04 |
| S5 | 1.2750E−01 | 4.3286E−02 | 7.3338E−03 | −2.2457E−03 | 9.3128E−05 | −1.2300E−03 | 2.0963E−04 |
| S6 | −1.1626E−01 | 1.1227E−02 | −3.8562E−03 | −7.3267E−03 | 7.4200E−04 | 1.1052E−04 | −2.1205E−04 |
| S7 | −8.1483E−02 | −1.2415E−02 | 5.4465E−03 | −2.7659E−03 | −3.0099E−05 | −3.0352E−04 | −3.5629E−04 |
| S8 | 1.4425E−02 | 1.7167E−02 | 1.4554E−02 | 7.9512E−03 | 2.6783E−03 | 1.1057E−03 | 2.9233E−04 |
| S9 | −3.6639E−01 | 1.6351E−02 | 3.8030E−03 | 1.3452E−03 | −8.0222E−04 | −6.1187E−04 | −2.7493E−04 |
| S10 | −3.9003E−01 | 4.9977E−02 | 8.2077E−03 | −2.4601E−03 | −3.6824E−03 | −1.3989E−03 | −6.5685E−05 |
| S11 | −5.5371E−01 | −4.9822E−02 | 1.0403E−02 | 7.5344E−03 | 1.9229E−03 | 1.2086E−04 | −4.9728E−04 |
| S12 | −6.3680E−01 | −2.6369E−02 | 9.3531E−03 | 1.1781E−02 | 5.5238E−03 | 4.8038E−03 | 1.6304E−03 |
| S13 | −1.5458E+00 | 2.1366E−01 | −3.8575E−02 | 4.2532E−02 | 4.8074E−03 | 6.4732E−03 | −4.2123E−03 |
| S14 | −2.5803E+00 | 2.1617E−01 | −1.2480E−01 | 2.6864E−02 | −9.0301E−03 | 9.9961E−03 | −5.7548E−04 |
| Surface | | | | | | | |
| number | A18 | A20 | A22 | A24 | A26 | A28 | A30 |
| S1 | −1.8596E−04 | 4.2876E−05 | −3.6403E−05 | 4.4527E−05 | −2.3372E−05 | 1.2323E−05 | −2.3440E−05 |
| S2 | 2.2277E−04 | −8.3095E−05 | 4.6480E−05 | 2.2244E−05 | −4.5700E−05 | 4.4845E−05 | −3.1955E−05 |
| S3 | 1.8726E−05 | 9.6929E−05 | −1.2164E−04 | 1.6723E−04 | −1.2550E−04 | 7.8945E−05 | −3.2688E−05 |
| S4 | −2.0547E−04 | 7.9299E−05 | −2.6017E−04 | 2.3591E−04 | −6.5874E−05 | 2.5574E−06 | −6.7301E−06 |
| S5 | −3.1869E−04 | −1.4752E−05 | −3.3621E−04 | 1.3572E−04 | −5.7362E−05 | −3.8242E−07 | −3.7881E−05 |
| S6 | −9.1476E−05 | 8.9727E−05 | −4.5544E−07 | 5.7712E−06 | −1.3705E−05 | −6.0715E−06 | 6.2345E−06 |
| S7 | −7.6204E−05 | 1.1576E−04 | 5.8346E−06 | 4.6675E−06 | −1.6271E−05 | −2.1506E−06 | 6.4262E−06 |
| S8 | 1.7197E−04 | 1.0361E−04 | 1.0023E−04 | 5.0299E−05 | 4.3046E−05 | 1.1468E−05 | 1.5105E−05 |
| S9 | 2.9541E−05 | 9.0152E−05 | 1.0123E−04 | 5.3681E−05 | 3.8132E−05 | 1.9895E−05 | 1.3360E−05 |
| S10 | 3.8368E−04 | 2.3503E−04 | 5.4505E−05 | −6.4145E−05 | −5.5042E−05 | −3.2894E−05 | −2.6960E−06 |
| S11 | −3.9351E−04 | −1.1669E−04 | 5.0869E−05 | 1.1382E−04 | 6.8935E−05 | 3.5502E−05 | 5.2521E−06 |
| S12 | 5.8410E−04 | 1.8246E−05 | −5.2403E−05 | −8.7292E−05 | −6.8484E−05 | −5.1238E−05 | −2.8301E−05 |
| S13 | −2.2474E−03 | −8.0102E−04 | 3.3405E−04 | 2.5211E−04 | 9.9062E−05 | 3.0894E−05 | −4.1448E−05 |
| S14 | 1.6526E−03 | −1.2391E−04 | 4.8493E−04 | −9.9725E−06 | 1.2883E−04 | 5.1817E−06 | −4.2227E−05 |

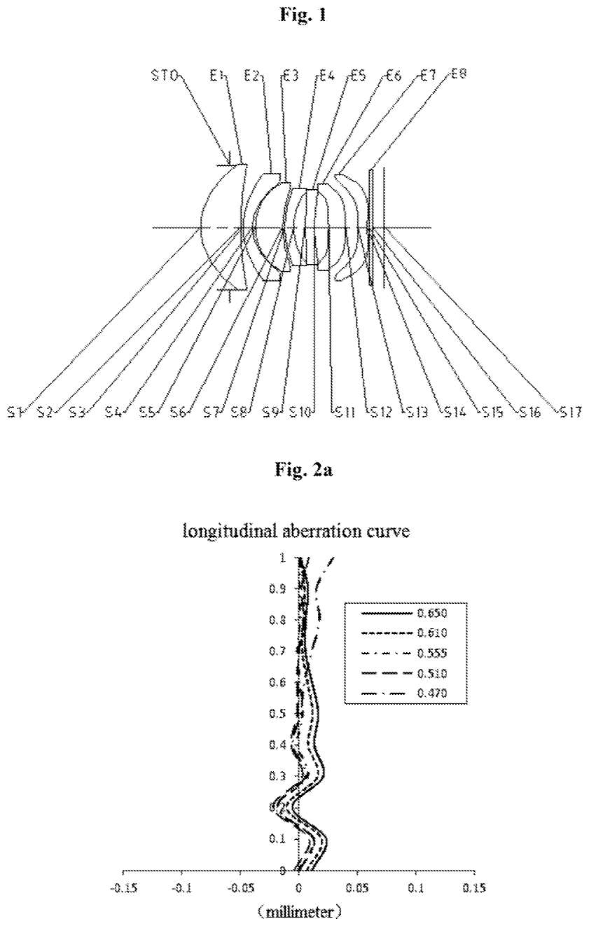

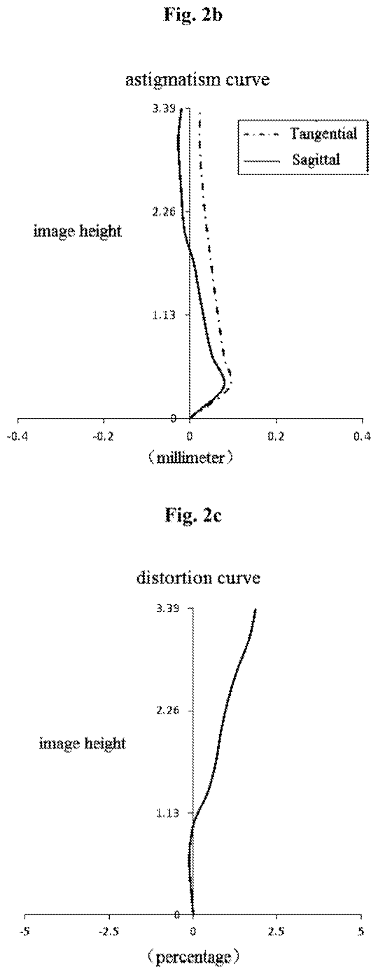

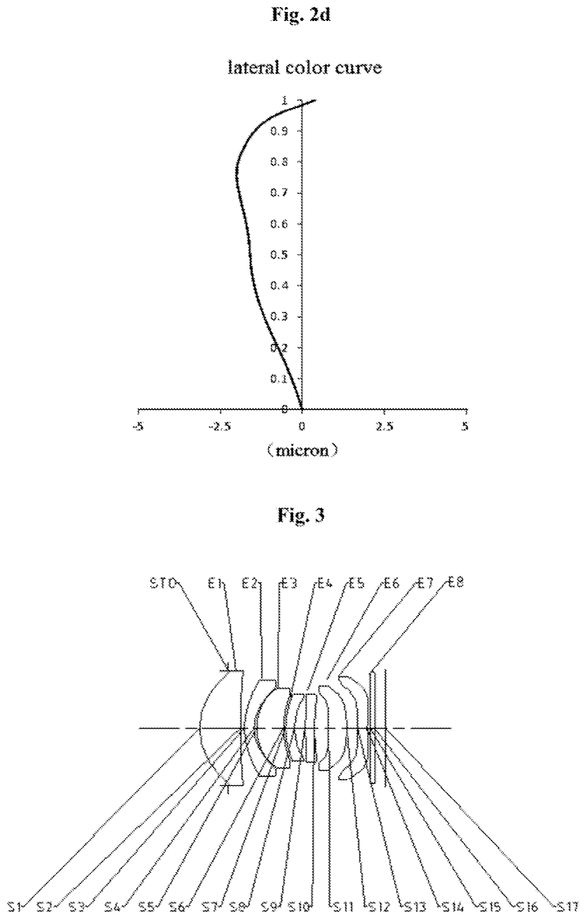

FIG. 2a shows a longitudinal aberration curve of the optical imaging system according to Embodiment 1 to represent deviations of a convergence focal point after lights with different wavelengths pass through the lens. FIG. 2b shows an astigmatism curve of the optical imaging system according to Embodiment 1 to represent a tangential image surface curvature and a sagittal image surface curvature. FIG. 2c shows a distortion curve of the optical imaging system according to Embodiment 1 to represent distortion values corresponding to different image heights. FIG. 2d shows a lateral color curve of the optical imaging system according to Embodiment 1 to represent deviations of different image heights on the imaging surface after light passes through the lens. According to FIGS. 2a-2d, it can be seen that the optical imaging system provided in Embodiment 1 may achieve high imaging quality.

### Embodiment 2

FIG. 3 shows a structural schematic diagram of a lens group of an optical imaging system according to Embodiment 2 of the disclosure. The optical imaging system sequentially includes from an object side to an image side along an optical axis: a diaphragm STO, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, and an image-side surface S2 thereof is a convex surface. The second lens E2 has a negative refractive power, an object-side surface S3 thereof is a convex surface, and an image-side surface S4 thereof is a concave surface. The third lens E3 has a positive refractive power, an object-side surface S5 thereof is a convex surface, and an image-side surface S6 thereof is a concave surface. The fourth lens E4 has a negative refractive power, an object-side surface S7 thereof is a convex surface, and an image-side surface S8 thereof is a concave surface. The fifth lens E5 has a positive refractive power, an object-side surface S9 thereof is a convex surface, and an image-side surface S10 thereof is a concave surface. The sixth lens E6 has a positive refractive power, an object-side surface S11 thereof is a convex surface, and an image-side surface S12 thereof is a convex surface. The seventh lens E7 has a negative refractive power, an object-side surface S13 thereof is a convex surface, and an image-side surface S14 thereof is a concave surface. The optical filter E8 has an object-side surface S15 and an image-side surface S16. Light from an object sequentially penetrates through each of the surfaces S1 to S16, and is finally imaged on the imaging surface S17.

Table 4 shows a basic parameter table of the optical imaging system of Embodiment 2, wherein units of the curvature radius, the thickness and the focal length are all millimeters (mm).

TABLE 4

| Surface | Surface | Curvature | Thickness/ | Focal | Refractive | Abbe | Conic |
|---|---|---|---|---|---|---|---|
| number | type | radius | distance | length | index | number | coefficient |
| OBJ | Spherical | Infinite | Infinite | | | | |
| STO | Spherical | Infinite | −1.5000 | | | | |
| S1 | Aspheric | 3.9409 | 2.1266 | 7.18 | 1.55 | 56.1 | −1.0397 |
| S2 | Aspheric | −549.9446 | 0.1981 | | | | −95.7730 |
| S3 | Aspheric | 4.5778 | 0.5046 | −9.77 | 1.68 | 19.2 | 0.0446 |
| S4 | Aspheric | 2.5844 | 0.1327 | | | | −1.0817 |
| S5 | Aspheric | 3.4679 | 1.3877 | 15.72 | 1.55 | 56.1 | 0.0032 |
| S6 | Aspheric | 4.9982 | 0.1063 | | | | 0.2543 |
| S7 | Aspheric | 4.9345 | 0.4649 | −22.21 | 1.68 | 19.2 | 0.3933 |
| S8 | Aspheric | 3.5739 | 0.5469 | | | | 0.1675 |
| S9 | Aspheric | 5.0629 | 0.4815 | 140.77 | 1.68 | 19.2 | 0.5888 |
| S10 | Aspheric | 5.1417 | 0.7613 | | | | 0.9165 |
| S11 | Aspheric | 483.4549 | 0.9295 | 19.18 | 1.68 | 19.2 | 99.0000 |
| S12 | Aspheric | −13.3318 | 0.5717 | | | | 25.5624 |
| S13 | Aspheric | 7.3702 | 0.4899 | −14.39 | 1.54 | 55.7 | −34.3546 |
| S14 | Aspheric | 3.6836 | 0.1698 | | | | −0.2425 |
| S15 | Spherical | Infinite | 0.2100 | | 1.52 | 64.2 | |
| S16 | Spherical | Infinite | 0.5900 | | | | |
| S17 | Spherical | Infinite | | | | | |

As shown in Table 5, in Embodiment 2, f is a total effective focal length of the optical imaging system, and f is 8.47 mm. TTL is a distance from the object-side surface S1 of the first lens E1 to the imaging surface S17 on the optical axis, and TTL is 9.67 mm. ImgH is a half of a diagonal length of an effective pixel region on the imaging surface S17, and ImgH is 3.39 mm. Semi-FOV is a half of a maximum field of view of the optical imaging system, and Semi-FOV is 20.3°. Explanations about parameters of each relational expression are the same as those in Embodiment 1. Numerical values of each relational expression are listed in the following Table.

TABLE 5
Embodiment 2

| | | | |
|---|---|---|---|
| f(mm) | 8.47 | TTL(mm) | 9.67 |
| ImgH(mm) | 3.39 | Semi-FOV(°) | 20.3 |
| f/EPD | 1.27 | (f1 + R1)/f | 1.31 |
| f2/R3 | −2.13 | f/R4 | 3.28 |
| f3/R5 | 4.53 | (f4 + R8)/f | −2.20 |
| f6/R12 | −1.44 | f7/R14 | −3.91 |
| CT1/CT2 | 4.21 | CT3/CT5 | 2.88 |
| 1/(T45 × T34)(mm⁻²) | 17.20 | TTL/ImgH | 2.85 |

In Embodiment 2, both the object-side surface and the image-side surface of any lens in the first lens E1 to the seventh lens E7 are aspheric surfaces. Table 6 shows high-order coefficients A4, A6, A8, A10, A12, A14, A16, A18, A20, A22, A24, A26, A28 and A30 that may be used for each of the aspheric mirror surfaces S1 to S14 in Embodiment 2.

TABLE 6

| Surface | | | | | | | |
|---|---|---|---|---|---|---|---|
| number | A4 | A6 | A8 | A10 | A12 | A14 | A16 |
| S1 | 2.0917E−01 | 8.1604E−03 | 1.0651E−03 | 6.3923E−04 | 2.5606E−04 | −4.6146E−05 | −2.7840E−05 |
| S2 | 1.3726E−01 | −1.4651E−02 | 5.7915E−03 | −1.1530E−03 | 9.0136E−05 | −3.6936E−04 | 2.6466E−04 |
| S3 | −1.8587E−01 | 1.4937E−03 | 4.6467E−03 | −9.3548E−04 | −4.7707E−04 | −4.8842E−04 | 5.3944E−04 |
| S4 | 5.9016E−02 | 5.3669E−03 | 4.0561E−03 | −5.1986E−04 | −5.7623E−04 | −9.7816E−04 | 5.4404E−04 |
| S5 | 7.8625E−02 | 1.9721E−02 | 6.6369E−03 | −2.9229E−04 | −3.6280E−04 | −8.4224E−04 | 8.4993E−05 |
| S6 | −7.0864E−02 | 1.0858E−02 | 2.2519E−04 | −8.4843E−04 | −1.3497E−03 | 4.6696E−04 | −1.4851E−04 |
| S7 | −3.4353E−02 | −5.0076E−03 | −1.8321E−04 | 4.3579E−04 | −1.5069E−03 | 3.9033E−04 | −9.8445E−05 |
| S8 | 2.9993E−03 | 3.3699E−03 | 4.0129E−03 | 3.1444E−03 | −1.8310E−04 | 1.0082E−04 | −1.6155E−04 |
| S9 | −3.2364E−01 | 1.5925E−02 | 6.1599E−03 | 3.9981E−03 | 5.4021E−04 | 7.5768E−05 | −2.9632E−05 |
| S10 | −3.4259E−01 | 4.7132E−02 | 1.5186E−02 | 4.3885E−03 | −3.4140E−04 | −7.2905E−04 | −6.8765E−04 |
| S11 | −4.6122E−01 | −4.0606E−02 | 7.7796E−03 | 5.7015E−03 | 2.1151E−03 | 1.2493E−03 | 8.5515E−04 |
| S12 | −6.2876E−01 | −3.2974E−02 | 7.4007E−03 | 6.2875E−03 | 2.8805E−03 | 4.2132E−03 | 2.7633E−03 |
| S13 | −1.5572E+00 | 2.0333E−01 | 2.3408E−03 | 4.0605E−02 | 1.1533E−02 | 8.1324E−03 | −3.3750E−03 |
| S14 | −2.6240E+00 | 1.6241E−01 | −7.4537E−02 | 3.0931E−02 | 8.5382E−03 | 1.8991E−02 | 1.0644E−02 |
| Surface | | | | | | | |
| number | A18 | A20 | A22 | A24 | A26 | A28 | A30 |
| S1 | −6.9014E−06 | 2.0104E−05 | 1.2118E−05 | 1.4415E−05 | 9.7135E−06 | 8.7766E−06 | −1.0060E−06 |
| S2 | −1.5893E−04 | 8.4023E−05 | −6.4235E−05 | 1.4164E−05 | −2.8653E−05 | −4.3871E−06 | −1.0406E−05 |
| S3 | −1.1226E−04 | 9.0456E−05 | −4.4191E−05 | −2.5038E−06 | −2.4495E−05 | −1.0792E−05 | −4.0641E−06 |
| S4 | 3.6703E−04 | 3.6432E−04 | 2.3708E−04 | 1.6988E−04 | 6.6316E−05 | −9.6889E−06 | −2.1056E−05 |
| S5 | 1.1379E−04 | 1.7461E−04 | 1.5425E−04 | 1.5329E−04 | 8.4433E−05 | 1.1059E−05 | −1.6178E−05 |
| S6 | −1.2360E−04 | −1.9819E−05 | −2.2983E−05 | 3.9304E−06 | −1.5505E−06 | 7.7194E−06 | 1.1609E−06 |
| S7 | −1.0087E−04 | −1.2899E−05 | −1.5414E−05 | 3.7673E−06 | −4.1313E−06 | 3.5298E−06 | −2.7972E−07 |
| S8 | −9.6733E−05 | −2.1793E−06 | 2.8949E−05 | 3.2320E−05 | 2.0254E−05 | 1.1180E−05 | 3.0806E−06 |
| S9 | −1.2319E−05 | 8.9163E−06 | 3.5319E−05 | 3.5595E−05 | 3.0078E−05 | 1.4925E−05 | 7.0686E−06 |
| S10 | −5.6742E−04 | −4.1122E−04 | −2.5244E−04 | −1.3270E−04 | −5.8562E−05 | −2.1897E−05 | −5.0327E−06 |
| S11 | 4.4256E−04 | 1.0370E−04 | −6.2585E−05 | −8.9746E−05 | −6.7533E−05 | −3.7310E−05 | −1.6613E−05 |
| S12 | 1.5510E−03 | 5.8620E−04 | 1.8207E−04 | 4.6957E−06 | −2.2772E−05 | −2.2835E−05 | −5.3756E−06 |
| S13 | −4.6110E−03 | −2.4453E−03 | −2.0004E−04 | 3.6759E−04 | 4.5013E−04 | 2.8521E−04 | 1.7544E−04 |
| S14 | 7.8196E−03 | 4.6854E−03 | 3.2891E−03 | 1.8852E−03 | 1.0616E−03 | 4.3674E−04 | 2.1375E−04 |

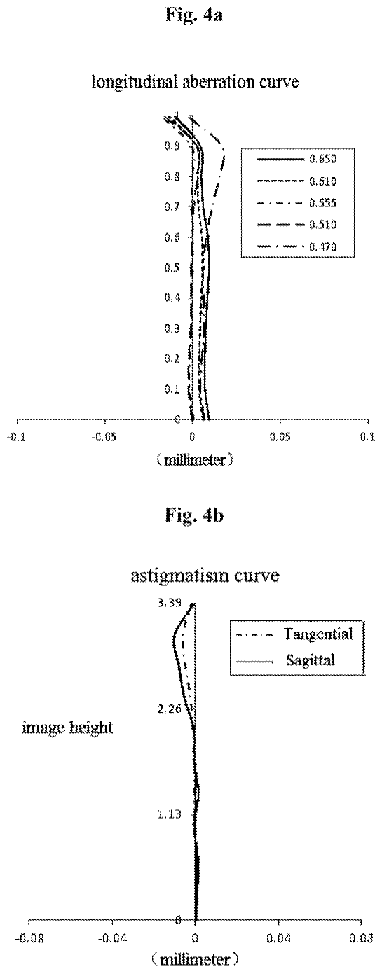

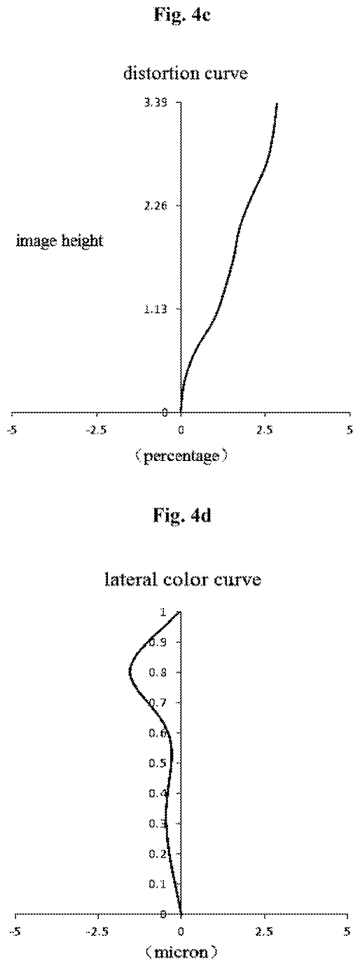

FIG. 4a shows a longitudinal aberration curve of the optical imaging system according to Embodiment 2 to represent deviations of a convergence focal point after lights with different wavelengths pass through the lens. FIG. 4b shows an astigmatism curve of the optical imaging system according to Embodiment 2 to represent a tangential image surface curvature and a sagittal image surface curvature. FIG. 4c shows a distortion curve of the optical imaging system according to Embodiment 2 to represent distortion values corresponding to different image heights. FIG. 4d shows a lateral color curve of the optical imaging system according to Embodiment 2 to represent deviations of different image heights on the imaging surface after the light passes through the lens. According to FIGS. 4a-4d, it can be seen that the optical imaging system provided in Embodiment 2 may achieve high imaging quality.

### Embodiment 3

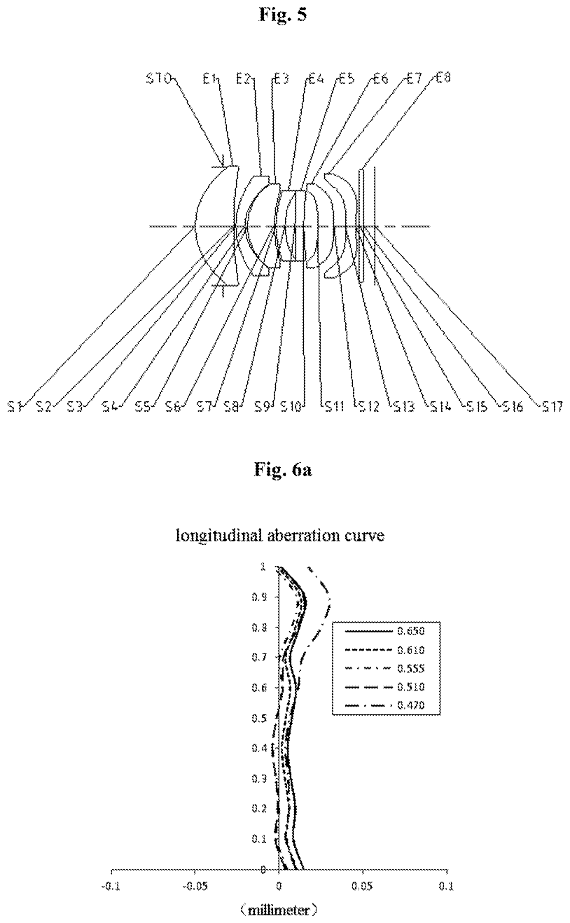

FIG. 5 shows a structural schematic diagram of a lens group of an optical imaging system according to Embodiment 3 of the disclosure. The optical imaging system sequentially includes from an object side to an image side along an optical axis: a diaphragm STO, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, and an image-side surface S2 thereof is a concave surface. The second lens E2 has a negative refractive power, an object-side surface S3 thereof is a convex surface, and an image-side surface S4 thereof is a concave surface. The third lens E3 has a positive refractive power, an object-side surface S5 thereof is a convex surface, and an image-side surface S6 thereof is a concave surface. The fourth lens E4 has a negative refractive power, an object-side surface S7 thereof is a convex surface, and an image-side surface S8 thereof is a concave surface. The fifth lens E5 has a negative refractive power, an object-side surface S9 thereof is a convex surface, and an image-side surface S10 thereof is a concave surface. The sixth lens E6 has a positive refractive power, an object-side surface S11 thereof is a convex surface, and an image-side surface S12 thereof is a convex surface. The seventh lens E7 has a negative refractive power, an object-side surface S13 thereof is a convex surface, and an image-side surface S14 thereof is a concave surface. The optical filter E8 has an object-side surface S15 and an image-side surface S16. Light from an object sequentially penetrates through each of the surfaces S1 to S16, and is finally imaged on the imaging surface S17.

Table 7 shows a basic parameter table of the optical imaging system of Embodiment 3, wherein units of the curvature radius, the thickness and the focal length are all millimeters (mm).

TABLE 7

| Surface | Surface | Curvature | Thickness/ | Focal | Refractive | Abbe | Conic |
|---|---|---|---|---|---|---|---|
| number | type | radius | distance | length | index | number | coefficient |
| OBJ | Spherical | Infinite | Infinite | | | | |
| STO | Spherical | Infinite | −1.5000 | | | | |
| S1 | Aspheric | 3.8979 | 2.0721 | 7.71 | 1.55 | 56.1 | −1.0234 |
| S2 | Aspheric | 43.0214 | 0.1055 | | | | −14.5576 |
| S3 | Aspheric | 4.1553 | 0.4844 | −10.64 | 1.68 | 19.2 | 0.0164 |
| S4 | Aspheric | 2.5114 | 0.1459 | | | | −1.0638 |
| S5 | Aspheric | 3.3256 | 1.4129 | 12.67 | 1.55 | 56.1 | −0.0156 |
| S6 | Aspheric | 5.4435 | 0.1000 | | | | 0.1630 |
| S7 | Aspheric | 5.5112 | 0.4785 | −20.99 | 1.68 | 19.2 | 0.2100 |
| S8 | Aspheric | 3.8318 | 0.5388 | | | | 0.2305 |
| S9 | Aspheric | 5.4738 | 0.4668 | −761.32 | 1.68 | 19.2 | 0.8750 |
| S10 | Aspheric | 5.2298 | 0.7527 | | | | 0.5813 |
| S11 | Aspheric | 197.3376 | 0.8710 | 19.49 | 1.68 | 19.2 | 44.9351 |
| S12 | Aspheric | −14.1119 | 0.6058 | | | | 27.2118 |
| S13 | Aspheric | 8.6418 | 0.5354 | −14.34 | 1.54 | 55.7 | −57.4010 |
| S14 | Aspheric | 3.9825 | 0.2213 | | | | −0.3509 |
| S15 | Spherical | Infinite | 0.2100 | | 1.52 | 64.2 | |
| S16 | Spherical | Infinite | 0.5900 | | | | |
| S17 | Spherical | Infinite | | | | | |

As shown in Table 8, in Embodiment 3, f is a total effective focal length of the optical imaging system, and f is 8.45 mm. TTL is a distance from the object-side surface S1 of the first lens E1 to the imaging surface S17 on the optical axis, and TTL is 9.59 mm. ImgH is a half of a diagonal length of an effective pixel region on the imaging surface S17, and ImgH is 3.39 mm. Semi-FOV is a half of a maximum field of view of the optical imaging system, and Semi-FOV is 20.5°. Explanations about parameters of each relational expression are the same as those in Embodiment 1. Numerical values of each relational expression are listed in the following Table.

TABLE 8
Embodiment 3

| | | | |
|---|---|---|---|
| f(mm) | 8.45 | TTL(mm) | 9.59 |
| ImgH(mm) | 3.39 | Semi-FOV(°) | 20.5 |
| f/EPD | 1.24 | (f1 + R1)/f | 1.37 |
| f2/R3 | −2.56 | f/R4 | 3.37 |
| f3/R5 | 3.81 | (f4 + R8)/f | −2.03 |
| f6/R12 | −1.38 | f7/R14 | −3.60 |
| CT1/CT2 | 4.28 | CT3/CT5 | 3.03 |
| 1/(T45 × T34)(mm⁻²) | 18.57 | TTL/ImgH | 2.83 |

In Embodiment 3, both the object-side surface and the image-side surface of any lens in the first lens E1 to the seventh lens E7 are aspheric surfaces. Table 9 shows high-order coefficients A4, A6, A8, A10, A12, A14, A16, A18, A20, A22, A24, A26, A28 and A30 that can be used for each of the aspheric mirror surfaces S1 to S14 in Embodiment 3.

TABLE 9

| Surface | | | | | | | |
|---|---|---|---|---|---|---|---|
| number | A4 | A6 | A8 | A10 | A12 | A14 | A16 |
| S1 | 2.6812E−01 | 1.0733E−02 | 2.6875E−04 | 3.6184E−04 | 2.0742E−04 | −3.5291E−05 | −7.6041E−05 |
| S2 | 1.4674E−01 | −1.6383E−02 | 7.1534E−03 | −1.6796E−03 | 4.9352E−04 | −8.0414E−04 | 2.3856E−04 |
| S3 | −2.5570E−01 | 8.9285E−03 | 8.7911E−03 | −1.0906E−03 | 5.0497E−05 | −8.2789E−04 | 8.6416E−04 |
| S4 | 9.9291E−02 | 1.5947E−02 | 7.4266E−03 | −2.5031E−03 | −1.4863E−03 | −1.7310E−03 | 5.2142E−04 |
| S5 | 1.3641E−01 | 3.8070E−02 | 1.1221E−02 | −3.4038E−03 | −2.8033E−03 | −2.4656E−03 | −5.3500E−04 |
| S6 | −1.2007E−01 | 5.0058E−03 | −1.2147E−02 | −7.3048E−03 | −2.0830E−03 | 1.1485E−03 | 2.5672E−05 |
| S7 | −8.0693E−02 | −1.0208E−02 | −2.1986E−03 | −2.7949E−03 | −2.3161E−03 | 7.4115E−04 | 2.0175E−05 |
| S8 | 1.5671E−02 | 1.1130E−02 | 1.0477E−02 | 6.1752E−03 | 1.6651E−03 | 9.3123E−04 | 3.4160E−04 |
| S9 | −3.3534E−01 | 1.6233E−02 | 7.0346E−03 | 3.2087E−03 | 2.8790E−04 | −1.8659E−05 | 8.9321E−05 |
| S10 | −3.7271E−01 | 4.7807E−02 | 9.4618E−03 | −1.8955E−03 | −3.4442E−03 | −1.5531E−03 | −3.2588E−04 |
| S11 | −5.5743E−01 | −6.4628E−02 | 8.8282E−04 | 5.0825E−03 | 3.3114E−03 | 2.6992E−03 | 1.6684E−03 |
| S12 | −6.8744E−01 | −3.6548E−02 | 5.4689E−03 | 1.0056E−02 | 7.4326E−03 | 7.0640E−03 | 4.1870E−03 |
| S13 | −1.7043E+00 | 2.5464E−01 | 1.7135E−02 | 4.4259E−02 | 1.0519E−02 | −1.2254E−03 | −7.6147E−03 |
| S14 | −2.6610E+00 | 1.4759E−01 | −9.6154E−02 | 1.0136E−02 | −1.5509E−03 | 6.3331E−03 | 1.2204E−03 |
| Surface | | | | | | | |
| number | A18 | A20 | A22 | A24 | A26 | A28 | A30 |
| S1 | −1.1460E−04 | −8.3710E−05 | −5.0128E−05 | −1.4900E−05 | −5.3376E−05 | −3.8349E−05 | −8.2391E−06 |
| S2 | −4.6518E−04 | 3.2435E−05 | −3.0334E−04 | −6.5795E−05 | −8.4824E−05 | 5.1298E−07 | −2.7375E−05 |
| S3 | −1.0469E−04 | 2.1074E−04 | −1.6672E−04 | −5.1102E−05 | −2.1390E−05 | 1.7540E−05 | 2.6524E−07 |
| S4 | 1.8932E−04 | 2.5194E−04 | 2.7737E−06 | −8.4924E−05 | −4.1495E−05 | −7.5950E−06 | −8.1938E−06 |
| S5 | −4.2664E−04 | −1.5161E−04 | −1.2249E−04 | −1.0375E−04 | −4.2331E−05 | −1.8690E−05 | −4.2335E−05 |
| S6 | 6.9500E−05 | 4.8674E−05 | −1.1091E−04 | −1.4309E−04 | −1.2572E−04 | −4.7474E−05 | −1.7316E−06 |
| S7 | 1.3839E−04 | 1.5383E−04 | 5.1971E−05 | −1.6290E−07 | −1.4989E−05 | −9.3596E−06 | 3.9672E−06 |
| S8 | 1.9193E−04 | 1.4021E−04 | 9.3328E−05 | 4.4152E−05 | 2.6805E−05 | 7.4322E−06 | −9.4147E−06 |
| S9 | 1.4095E−04 | 1.1806E−04 | 7.4396E−05 | 3.7958E−05 | 2.8534E−06 | −1.6297E−05 | −2.0088E−05 |
| S10 | 1.1392E−04 | 1.6156E−04 | 8.7638E−05 | 2.7404E−05 | −6.0726E−06 | −1.5836E−05 | −1.2217E−05 |
| S11 | 8.8543E−04 | 3.4264E−04 | 1.2978E−04 | 2.7594E−05 | −2.4593E−06 | −1.0705E−05 | −5.7755E−06 |
| S12 | 2.3334E−03 | 1.0658E−03 | 4.7613E−04 | 1.3603E−04 | 1.5650E−05 | −4.0551E−05 | −2.6661E−05 |
| S13 | −3.3176E−03 | 5.7777E−04 | 1.1332E−03 | 5.0072E−04 | 1.8571E−04 | 1.3645E−04 | 1.5814E−04 |
| S14 | 9.5308E−04 | 6.1463E−04 | 5.2923E−04 | 3.3178E−04 | 2.3428E−04 | 8.4592E−05 | 1.2096E−04 |

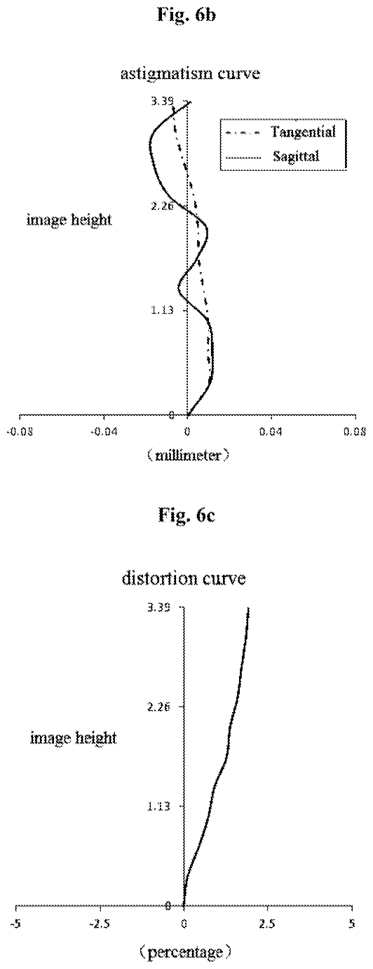

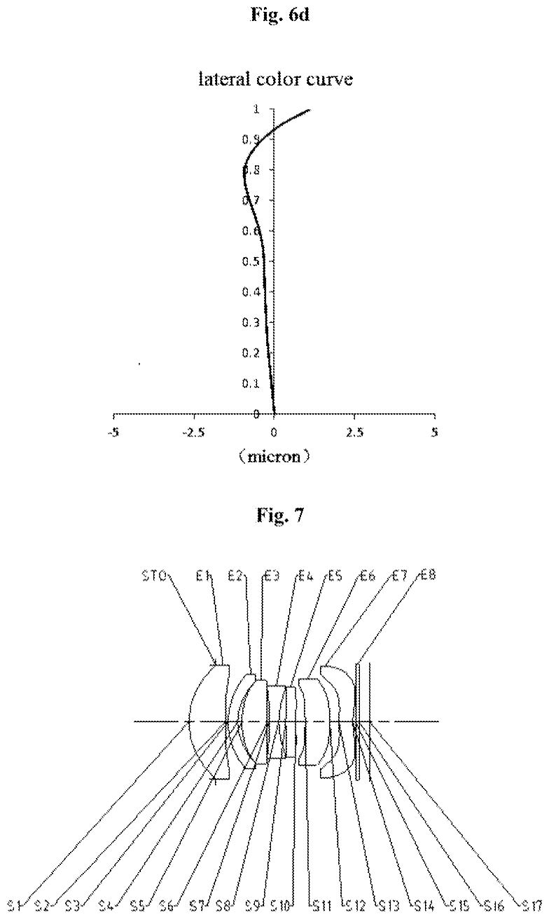

FIG. 6a shows a longitudinal aberration curve of the optical imaging system according to Embodiment 3 to represent deviations of a convergence focal point after lights with different wavelengths pass through the lens. FIG. 6b shows an astigmatism curve of the optical imaging system according to Embodiment 3 to represent a tangential image surface curvature and a sagittal image surface curvature. FIG. 6c shows a distortion curve of the optical imaging system according to Embodiment 3 to represent distortion values corresponding to different image heights. FIG. 6d shows a lateral color curve of the optical imaging system according to Embodiment 3 to represent deviations of different image heights on the imaging surface after the light passes through the lens. According to FIGS. 6a-6d, it can be seen that the optical imaging system provided in Embodiment 3 may achieve high imaging quality.

### Embodiment 4

FIG. 7 shows a structural schematic diagram of a lens group of an optical imaging system according to Embodiment 4 of the disclosure. The optical imaging system sequentially includes from an object side to an image side along an optical axis: a diaphragm STO, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, and an image-side surface S2 thereof is a concave surface. The second lens E2 has a negative refractive power, an object-side surface S3 thereof is a convex surface, and an image-side surface S4 thereof is a concave surface. The third lens E3 has a positive refractive power, an object-side surface S5 thereof is a convex surface, and an image-side surface S6 thereof is a concave surface. The fourth lens E4 has a negative refractive power, an object-side surface S7 thereof is a concave surface, and an image-side surface S8 thereof is a concave surface. The fifth lens E5 has a positive refractive power, an object-side surface S9 thereof is a convex surface, and an image-side surface S10 thereof is a concave surface. The sixth lens E6 has a positive refractive power, an object-side surface S11 thereof is a convex surface, and an image-side surface S12 thereof is a convex surface. The seventh lens E7 has a negative refractive power, an object-side surface S13 thereof is a convex surface, and an image-side surface S14 thereof is a concave surface. The optical filter E8 has an object-side surface S15 and an image-side surface S16. Light from an object sequentially penetrates through each of the surfaces S1 to S16, and is finally imaged on the imaging surface S17.

Table 10 shows a basic parameter table of the optical imaging system of Embodiment 4, wherein units of the curvature radius, the thickness and the focal length are all millimeters (mm).

TABLE 10

| Surface | Surface | Curvature | Thickness/ | Focal | Refractive | Abbe | Conic |
|---|---|---|---|---|---|---|---|
| number | type | radius | distance | length | index | number | coefficient |
| OBJ | Spherical | Infinite | Infinite | | | | |
| STO | Spherical | Infinite | −1.5000 | | | | |
| S1 | Aspheric | 4.1695 | 2.0305 | 8.43 | 1.55 | 56.1 | −1.0002 |
| S2 | Aspheric | 36.8743 | 0.1367 | | | | 3.9126 |
| S3 | Aspheric | 3.8345 | 0.5373 | −24.29 | 1.68 | 19.2 | 0.0800 |
| S4 | Aspheric | 2.9335 | 0.2291 | | | | −1.1947 |
| S5 | Aspheric | 4.6156 | 1.4260 | 8.99 | 1.55 | 56.1 | −0.0136 |
| S6 | Aspheric | 69.2268 | 0.1000 | | | | 78.8023 |
| S7 | Aspheric | −39.0000 | 0.5219 | −6.40 | 1.68 | 19.2 | −99.0000 |
| S8 | Aspheric | 4.8980 | 0.3850 | | | | −0.6492 |
| S9 | Aspheric | 6.2214 | 0.5501 | 48.48 | 1.68 | 19.2 | 1.3845 |
| S10 | Aspheric | 7.4025 | 0.5408 | | | | 1.5328 |
| S11 | Aspheric | 419.4797 | 1.3602 | 20.99 | 1.68 | 19.2 | 99.0000 |
| S12 | Aspheric | −14.6861 | 0.5099 | | | | −98.9804 |
| S13 | Aspheric | 5.6397 | 0.7559 | −16.12 | 1.54 | 55.7 | −39.5964 |
| S14 | Aspheric | 3.2541 | 0.1609 | | | | −0.1382 |
| S15 | Spherical | Infinite | 0.2100 | | 1.52 | 64.2 | |
| S16 | Spherical | Infinite | 0.5900 | | | | |
| S17 | Spherical | Infinite | | | | | |

As shown in Table 11, in Embodiment 4, f is a total effective focal length of the optical imaging system, and f is 8.26 mm. TTL is a distance from the object-side surface S1 of the first lens E1 to the imaging surface S17 on the optical axis, and TTL is 10.04 mm. ImgH is a half of a diagonal length of an effective pixel region on the imaging surface S17, and ImgH is 3.39 mm. Semi-FOV is a half of a maximum field of view of the optical imaging system, and Semi-FOV is 21.2°. Explanations about parameters of each relational expression are the same as those in Embodiment 1. Numerical values of each relational expression are listed in the following Table.

TABLE 11
Embodiment 4

| | | | |
|---|---|---|---|
| f(mm) | 8.26 | TTL(mm) | 10.04 |
| ImgH(mm) | 3.39 | Semi-FOV(°) | 21.2 |
| f/EPD | 1.27 | (f1 + R1)/f | 1.53 |
| f2/R3 | −6.33 | f/R4 | 2.81 |
| f3/R5 | 1.95 | (f4 + R8)/f | −0.18 |
| f6/R12 | −1.43 | f7/R14 | −4.95 |
| CT1/CT2 | 3.78 | CT3/CT5 | 2.59 |
| 1/(T45 × T34)(mm⁻²) | 25.98 | TTL/ImgH | 2.96 |

In Embodiment 4, both the object-side surface and the image-side surface of any lens in the first lens E1 to the seventh lens E7 are aspheric surfaces. Table 12 shows high-order coefficients A4, A6, A8, A10, A12, A14, A16, A18, A20, A22, A24, A26, A28 and A30 that may be used for each of the aspheric mirror surfaces S1 to S14 in Embodiment 4.

TABLE 12

| Surface | | | | | | | |
|---|---|---|---|---|---|---|---|
| number | A4 | A6 | A8 | A10 | A12 | A14 | A16 |
| S1 | 2.3954E−01 | 1.1186E−02 | −2.3523E−03 | −1.9021E−03 | −1.4643E−03 | −9.1590E−04 | −3.4326E−04 |
| S2 | 1.2683E−01 | −5.3918E−03 | 5.9710E−04 | −1.0639E−03 | −1.5012E−03 | −3.9783E−04 | 3.7056E−04 |
| S3 | −1.7226E−01 | 3.6945E−03 | 9.5119E−03 | −8.6332E−04 | −3.0420E−03 | −2.2476E−03 | 3.7803E−04 |
| S4 | 5.6902E−02 | 7.4241E−03 | 1.0773E−02 | −1.9529E−03 | −1.4525E−03 | −2.7326E−03 | −1.5772E−04 |
| S5 | 1.1695E−01 | 3.0560E−02 | 9.6656E−03 | −2.7291E−03 | 4.1129E−04 | −7.7820E−04 | 5.7339E−04 |
| S6 | −8.5342E−02 | 1.2588E−02 | −5.9307E−03 | −1.7279E−03 | −2.0634E−04 | 4.7163E−04 | 5.8665E−04 |
| S7 | −7.2794E−02 | −1.5801E−02 | −2.1721E−03 | −1.1755E−03 | −8.8224E−04 | 6.0591E−04 | 3.8864E−04 |
| S8 | −5.7552E−03 | −1.2523E−02 | 7.5871E−03 | 6.4522E−03 | 1.9585E−03 | 1.0976E−03 | −1.9728E−04 |
| S9 | −3.4679E−01 | 1.8704E−02 | 7.7272E−03 | 5.4865E−03 | 1.4044E−03 | 9.6670E−04 | 3.1265E−04 |
| S10 | −3.7555E−01 | 5.3447E−02 | 8.0707E−03 | −2.1498E−03 | −3.4940E−03 | −1.3795E−03 | −4.3539E−04 |
| S11 | −4.0993E−01 | −2.8796E−02 | 1.9471E−03 | 2.1298E−03 | 1.0601E−03 | 6.2034E−04 | −1.8666E−04 |
| S12 | −6.2401E−01 | 3.7228E−02 | 7.0994E−03 | 1.5470E−02 | 6.9878E−03 | 5.4830E−03 | 2.6360E−03 |
| S13 | −1.6400E+00 | 2.7346E−01 | 1.0425E−01 | 1.1340E−01 | 5.7232E−02 | 1.9863E−02 | 1.9463E−03 |
| S14 | −2.8112E+00 | 5.5578E−02 | −1.0099E−01 | 1.2161E−03 | −8.7023E−03 | −1.4648E−03 | −7.0738E−04 |
| Surface | | | | | | | |
| number | A18 | A20 | A22 | A24 | A26 | A28 | A30 |
| S1 | −6.0247E−05 | 2.5524E−05 | 3.4204E−05 | 3.8673E−05 | 1.8414E−05 | 5.8313E−06 | −1.9720E−06 |
| S2 | −5.2377E−05 | 1.5626E−04 | 5.4003E−05 | 6.5713E−05 | 1.0253E−05 | 2.0421E−05 | 5.4293E−06 |
| S3 | −2.6690E−05 | 1.3126E−04 | 2.3986E−04 | 1.9691E−04 | 7.4624E−05 | 3.9310E−05 | 2.2894E−05 |
| S4 | −9.9557E−07 | −2.7442E−04 | −9.3523E−05 | 5.9657E−05 | 2.2812E−05 | −1.6571E−06 | 1.1303E−05 |
| S5 | 2.9680E−04 | −1.7736E−04 | −4.1737E−05 | 7.6479E−05 | 2.2344E−05 | 7.0443E−06 | 1.2171E−05 |
| S6 | 5.6137E−04 | 3.1785E−04 | 1.9216E−04 | 8.8316E−05 | 4.2737E−05 | 1.8663E−05 | 8.9051E−06 |
| S7 | 3.3084E−04 | 8.4389E−05 | 3.0237E−05 | −9.5138E−06 | −7.6087E−06 | −5.7633E−06 | −4.3446E−07 |
| S8 | −6.2742E−04 | −6.5853E−04 | −4.2122E−04 | −1.8760E−04 | −3.9421E−05 | 1.0538E−05 | 1.0115E−05 |
| S9 | −7.0852E−05 | −2.2043E−04 | −1.5728E−04 | −6.5121E−05 | 4.7828E−06 | 1.7915E−05 | 1.2234E−05 |
| S10 | 3.0452E−04 | 7.3112E−04 | 8.2777E−04 | 6.3433E−04 | 3.6973E−04 | 1.4819E−04 | 3.9332E−05 |
| S11 | −1.9266E−04 | 1.2697E−04 | 3.8832E−04 | 3.7473E−04 | 2.4974E−04 | 1.0650E−04 | 3.2592E−05 |
| S12 | 1.4103E−03 | 7.1118E−04 | 4.2391E−04 | 2.3606E−04 | 1.1182E−04 | 3.1469E−05 | 2.2009E−05 |
| S13 | −2.5150E−03 | −1.0875E−03 | −3.4063E−04 | −1.1718E−04 | −2.1840E−04 | −8.4564E−05 | 3.3521E−05 |
| S14 | −8.3822E−04 | −1.5090E−04 | −3.3991E−04 | 5.2807E−05 | −5.9656E−05 | −2.8274E−05 | −1.0826E−04 |

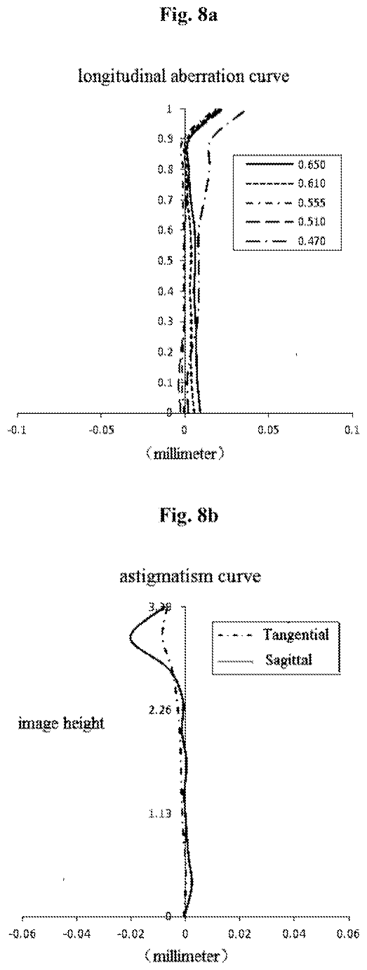

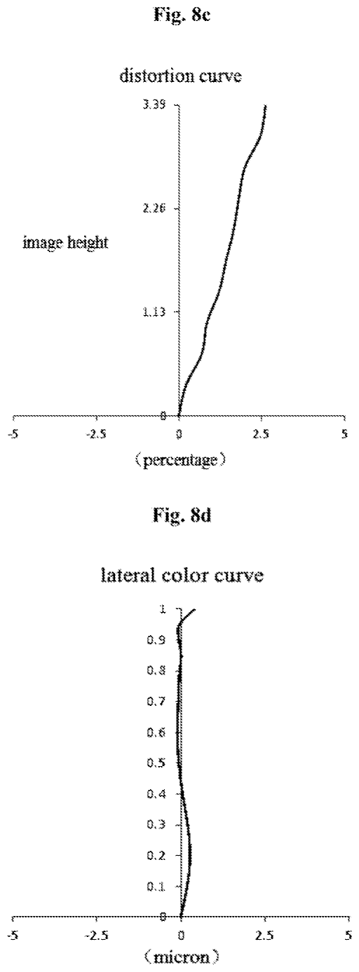

FIG. 8a shows a longitudinal aberration curve of the optical imaging system according to Embodiment 4 to represent deviations of a convergence focal point after lights with different wavelengths pass through the lens. FIG. 8b shows an astigmatism curve of the optical imaging system according to Embodiment 4 to represent a tangential image surface curvature and a sagittal image surface curvature. FIG. 8c shows a distortion curve of the optical imaging system according to Embodiment 4 to represent distortion values corresponding to different image heights. FIG. 8d shows a lateral color curve of the optical imaging system according to Embodiment 4 to represent deviations of different image heights on the imaging surface after the light passes through the lens. According to FIGS. 8a-8d, it can be seen that the optical imaging system provided in Embodiment 4 may achieve high imaging quality.

### Embodiment 5

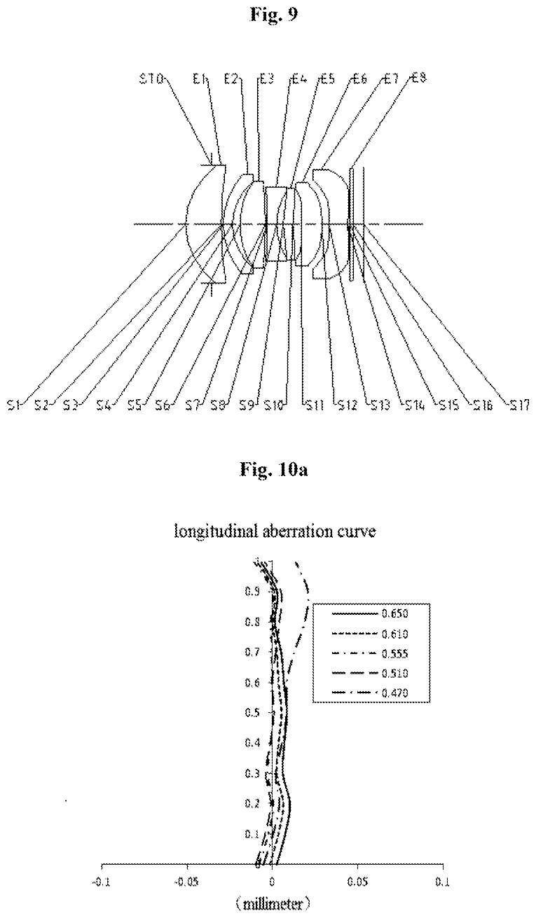

FIG. 9 shows a structural schematic diagram of a lens group of an optical imaging system according to Embodiment 5 of the disclosure. The optical imaging system sequentially includes from an object side to an image side along an optical axis: a diaphragm STO, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, and an image-side surface S2 thereof is a concave surface. The second lens E2 has a negative refractive power, an object-side surface S3 thereof is a convex surface, and an image-side surface S4 thereof is a concave surface. The third lens E3 has a positive refractive power, an object-side surface S5 thereof is a convex surface, and an image-side surface S6 thereof is a convex surface. The fourth lens E4 has a negative refractive power, an object-side surface S7 thereof is a convex surface, and an image-side surface S8 thereof is a concave surface. The fifth lens E5 has a positive refractive power, an object-side surface S9 thereof is a convex surface, and an image-side surface S10 thereof is a concave surface. The sixth lens E6 has a positive refractive power, an object-side surface S11 thereof is a convex surface, and an image-side surface S12 thereof is a convex surface. The seventh lens E7 has a negative refractive power, an object-side surface S13 thereof is a convex surface, and an image-side surface S14 thereof is a concave surface. The optical filter E8 has an object-side surface S15 and an image-side surface S16. Light from an object sequentially penetrates through each of the surfaces S1 to S16, and is finally imaged on the imaging surface S17.

Table 13 shows a basic parameter table of the optical imaging system of Embodiment 5, wherein units of the curvature radius, the thickness and the focal length are all millimeters (mm).

TABLE 13

| Surface | Surface | Curvature | Thickness/ | Focal | Refractive | Abbe | Conic |
|---|---|---|---|---|---|---|---|
| number | type | radius | distance | length | index | number | coefficient |
| OBJ | Spherical | Infinite | Infinite | | | | |
| STO | Spherical | Infinite | −1.5000 | | | | |
| S1 | Aspheric | 4.0980 | 2.0281 | 8.13 | 1.55 | 56.1 | −0.9926 |
| S2 | Aspheric | 43.7879 | 0.1035 | | | | 3.3036 |
| S3 | Aspheric | 3.9894 | 0.5280 | −24.96 | 1.68 | 19.2 | 0.0609 |
| S4 | Aspheric | 3.0551 | 0.4418 | | | | −1.1423 |
| S5 | Aspheric | 5.3528 | 1.4326 | 9.00 | 1.55 | 56.1 | −0.1526 |
| S6 | Aspheric | −54.1332 | 0.1000 | | | | −93.1417 |
| S7 | Aspheric | 265.3639 | 0.5382 | −5.73 | 1.68 | 19.2 | 99.0000 |
| S8 | Aspheric | 3.8180 | 0.3712 | | | | 0.0220 |
| S9 | Aspheric | 4.5018 | 0.5454 | 52.39 | 1.68 | 19.2 | 1.3217 |
| S10 | Aspheric | 4.9041 | 0.5109 | | | | 0.7616 |
| S11 | Aspheric | 52.4741 | 1.1390 | 19.58 | 1.68 | 19.2 | 99.0000 |
| S12 | Aspheric | −17.5745 | 0.4090 | | | | 40.6580 |
| S13 | Aspheric | 8.7034 | 1.0517 | −16.07 | 1.54 | 55.7 | −38.7732 |
| S14 | Aspheric | 4.1488 | 0.1180 | | | | 0.5748 |
| S15 | Spherical | Infinite | 0.2100 | | 1.52 | 64.2 | |
| S16 | Spherical | Infinite | 0.5900 | | | | |
| S17 | Spherical | Infinite | | | | | |

As shown in Table 14, in Embodiment 5, f is a total effective focal length of the optical imaging system, and f is 8.39 mm. TTL is a distance from the object-side surface S1 of the first lens E1 to the imaging surface S17 on the optical axis, and TTL is 10.12 mm. ImgH is a half of a diagonal length of an effective pixel region on the imaging surface S17, and ImgH is 3.39 mm. Semi-FOV is a half of a maximum field of view of the optical imaging system, and Semi-FOV is 21.3°. Explanations about parameters of each relational expression are the same as those in Embodiment 1. Numerical values of each relational expression are listed in the following Table.

TABLE 14
Embodiment 5

| | | | |
|---|---|---|---|
| f(mm) | 8.39 | TTL(mm) | 10.12 |
| ImgH(mm) | 3.39 | Semi-FOV(°) | 21.3 |
| f/EPD | 1.22 | (f1 + R1)/f | 1.46 |
| f2/R3 | −6.26 | f/R4 | 2.75 |
| f3/R5 | 1.68 | (f4 + R8)/f | −0.23 |
| f6/R12 | −1.11 | f7/R14 | −3.87 |
| CT1/CT2 | 3.84 | CT3/CT5 | 2.63 |
| 1/(T45 × T34)(mm⁻²) | 26.94 | TTL/ImgH | 2.99 |

In Embodiment 5, both the object-side surface and the image-side surface of any lens in the first lens E1 to the seventh lens E7 are aspheric surfaces. Table 15 shows high-order coefficients A4, A6, A8, A10, A12, A14, A16, A18, A20, A22, A24, A26, A28 and A30 that can be used for each of the aspheric mirror surfaces S1 to S14 in Embodiment 5.

TABLE 15

| Surface | | | | | | | |
|---|---|---|---|---|---|---|---|
| number | A4 | A6 | A8 | A10 | A12 | A14 | A16 |
| S1 | 2.6624E−01 | 1.2440E−02 | −3.6620E−03 | −2.7182E−03 | −1.9711E−03 | −1.5235E−03 | −8.8899E−04 |
| S2 | 1.4270E−01 | −6.7279E−03 | −2.5931E−03 | −3.5193E−03 | −3.3096E−03 | −1.4476E−03 | 9.3750E−05 |
| S3 | −1.9923E−01 | 2.8831E−03 | 1.0452E−02 | −4.5430E−04 | −2.6296E−03 | −2.5135E−03 | −3.6664E−04 |
| S4 | 9.1639E−02 | 2.0075E−02 | 1.3021E−02 | −1.4448E−03 | −1.9347E−03 | −2.5746E−03 | −1.4466E−03 |
| S5 | 1.1483E−01 | 3.0449E−02 | 7.6172E−03 | −2.8056E−03 | −1.0257E−03 | −1.3468E−03 | −1.1591E−03 |
| S6 | −6.6763E−02 | 1.4033E−02 | −1.0128E−03 | −2.0549E−03 | 2.0300E−04 | −3.7814E−04 | −2.0196E−04 |
| S7 | −6.6330E−02 | −1.1149E−02 | 2.2166E−03 | −1.0473E−03 | −2.6052E−04 | −5.4903E−05 | −1.9299E−04 |
| S8 | 5.8022E−03 | −6.1747E−03 | 2.3791E−03 | 2.7431E−03 | 5.0548E−04 | 9.2316E−04 | 4.1547E−04 |
| S9 | −3.2024E−01 | 1.5420E−02 | 3.5692E−04 | 3.1921E−03 | 2.6283E−05 | 4.7493E−04 | 2.9068E−04 |
| S10 | −3.4969E−01 | 3.9692E−02 | 9.0626E−03 | 3.3605E−03 | −1.4939E−03 | −6.2906E−04 | −3.9109E−04 |
| S11 | −3.2568E−01 | −1.0803E−02 | 5.7102E−03 | 2.4909E−03 | −1.7165E−03 | −1.1913E−03 | −7.3068E−04 |
| S12 | −5.6028E−01 | 3.3637E−02 | −8.3214E−03 | 6.1627E−03 | −1.2216E−03 | 7.9170E−04 | 2.0357E−04 |
| S13 | −1.1725E+00 | 1.2674E−01 | −2.9777E−02 | 1.0154E−02 | −2.0057E−04 | 2.0245E−03 | 6.6865E−04 |
| S14 | −2.4146E+00 | 1.7564E−02 | −8.0192E−02 | 5.9154E−03 | −6.8155E−03 | −2.0511E−04 | −2.2309E−04 |
| Surface | | | | | | | |
| number | A18 | A20 | A22 | A24 | A26 | A28 | A30 |
| S1 | −4.5000E−04 | −2.1941E−04 | −8.6267E−05 | −3.0482E−05 | −1.4467E−05 | −6.9668E−07 | −9.8617E−06 |
| S2 | −2.0118E−04 | 1.7873E−04 | 2.7409E−05 | −1.8379E−05 | 2.6783E−05 | −2.5483E−05 | 5.8358E−06 |
| S3 | −3.1825E−04 | −5.5545E−05 | 7.2228E−05 | −9.1665E−05 | 3.3803E−06 | −2.1230E−05 | −1.1209E−05 |
| S4 | −6.5715E−04 | −5.4701E−05 | 2.2714E−04 | 8.4868E−05 | 3.4779E−05 | 2.8303E−06 | −1.6940E−05 |
| S5 | −4.9967E−04 | −2.0841E−06 | 1.4262E−04 | 5.8576E−05 | 1.3644E−05 | −6.4040E−06 | −1.2511E−05 |
| S6 | 1.4044E−04 | −1.8690E−05 | 1.3529E−05 | 3.4332E−06 | −2.7308E−06 | 5.0413E−06 | −4.1032E−06 |
| S7 | 1.3233E−04 | −3.3644E−05 | 3.8274E−06 | 3.2245E−06 | 1.2169E−06 | 4.3675E−07 | −4.5004E−06 |
| S8 | 2.8349E−04 | 4.1156E−05 | −1.3754E−05 | −1.1776E−05 | −2.3137E−08 | 1.2221E−05 | 4.5887E−06 |
| S9 | 2.3892E−04 | 6.7116E−05 | −1.0873E−05 | −3.1687E−05 | −1.8571E−05 | −1.0527E−05 | −4.6775E−07 |
| S10 | −1.4895E−04 | −1.6172E−04 | −1.1680E−04 | −8.7050E−05 | −3.1812E−05 | −1.3195E−05 | 2.2487E−06 |
| S11 | −4.7363E−04 | −4.1651E−04 | −3.2916E−04 | −2.3856E−04 | −1.5122E−04 | −8.4986E−05 | −3.9313E−05 |
| S12 | 2.5803E−04 | 1.9861E−05 | 2.9415E−05 | −2.6557E−05 | −8.4915E−06 | −1.4510E−05 | 1.3881E−05 |
| S13 | 2.1565E−04 | −1.1918E−04 | −2.2017E−06 | −3.9320E−05 | 2.4466E−06 | −4.2120E−05 | 2.1436E−05 |
| S14 | −7.2420E−05 | −1.0894E−04 | −4.2044E−05 | −2.2763E−06 | 3.0075E−05 | 2.2850E−05 | −5.3717E−06 |

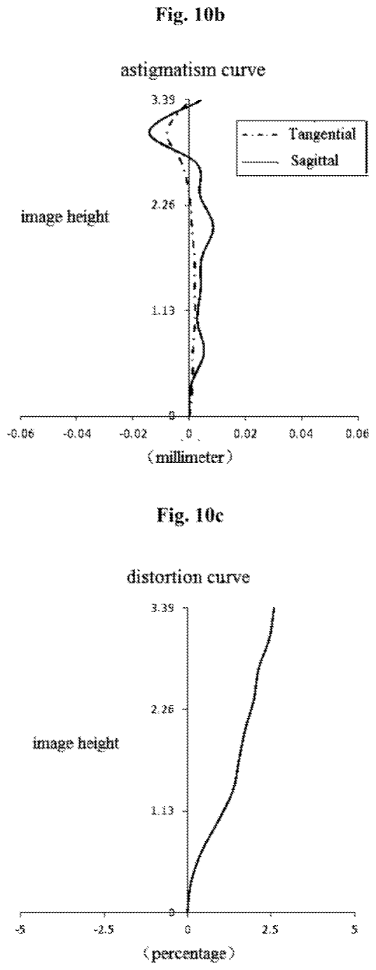

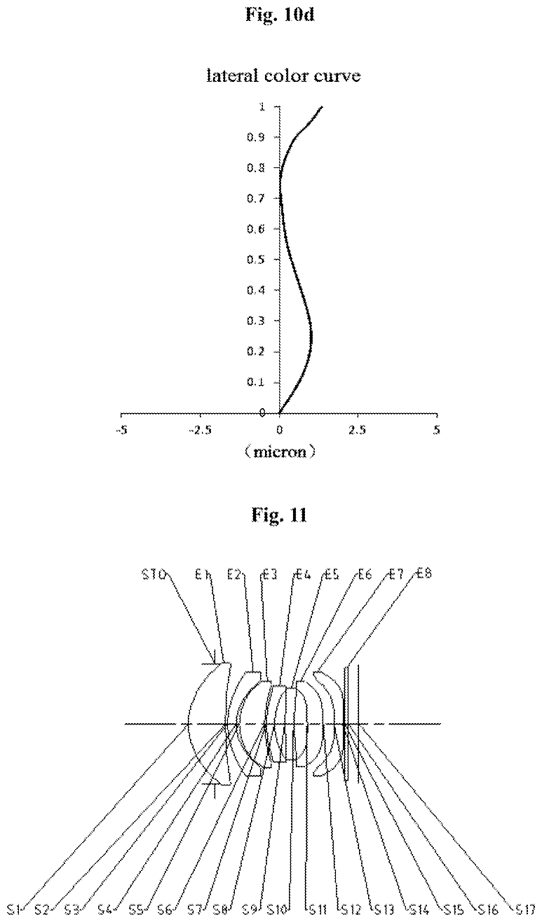

FIG. 10a shows a longitudinal aberration curve of the optical imaging system according to Embodiment 5 to represent deviations of a convergence focal point after lights with different wavelengths pass through the lens. FIG. 10b shows an astigmatism curve of the optical imaging system according to Embodiment 5 to represent a tangential image surface curvature and a sagittal image surface curvature. FIG. 10c shows a distortion curve of the optical imaging system according to Embodiment 5 to represent distortion values corresponding to different image heights. FIG. 10d shows a lateral color curve of the optical imaging system according to Embodiment 5 to represent deviations of different image heights on the imaging surface after the light passes through the lens. According to FIGS. 10a-10d, it can be seen that the optical imaging system provided in Embodiment 5 may achieve high imaging quality.

### Embodiment 6

FIG. 11 shows a structural schematic diagram of a lens group of an optical imaging system according to Embodiment 6 of the disclosure. The optical imaging system sequentially includes from an object side to an image side along an optical axis: a diaphragm STO, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, and an image-side surface S2 thereof is a concave surface. The second lens E2 has a negative refractive power, an object-side surface S3 thereof is a convex surface, and an image-side surface S4 thereof is a concave surface. The third lens E3 has a positive refractive power, an object-side surface S5 thereof is a convex surface, and an image-side surface S6 thereof is a concave surface. The fourth lens E4 has a negative refractive power, an object-side surface S7 thereof is a convex surface, and an image-side surface S8 thereof is a concave surface. The fifth lens E5 has a positive refractive power, an object-side surface S9 thereof is a convex surface, and an image-side surface S10 thereof is a concave surface. The sixth lens E6 has a positive refractive power, an object-side surface S11 thereof is a concave surface, and an image-side surface S12 thereof is a convex surface. The seventh lens E7 has a negative refractive power, an object-side surface S13 thereof is a convex surface, and an image-side surface S14 thereof is a concave surface. The optical filter E8 has an object-side surface S15 and an image-side surface S16. Light from an object sequentially penetrates through each of the surfaces S1 to S16, and is finally imaged on the imaging surface S17.

Table 16 shows a basic parameter table of the optical imaging system of Embodiment 6, wherein units of the curvature radius, the thickness and the focal length are all millimeters (mm).

TABLE 16

| Surface | Surface | Curvature | Thickness/ | Focal | Refractive | Abbe | Conic |
|---|---|---|---|---|---|---|---|
| number | type | radius | distance | length | index | number | coefficient |
| OBJ | Spherical | Infinite | Infinite | | | | |
| STO | Spherical | Infinite | −1.5000 | | | | |
| S1 | Aspheric | 3.8676 | 2.0821 | 7.73 | 1.55 | 56.1 | −1.0241 |
| S2 | Aspheric | 37.7731 | 0.1079 | | | | 6.1984 |
| S3 | Aspheric | 4.1264 | 0.4814 | −10.25 | 1.68 | 19.2 | 0.0011 |
| S4 | Aspheric | 2.4653 | 0.1938 | | | | −1.0410 |
| S5 | Aspheric | 3.2766 | 1.4018 | 13.10 | 1.55 | 56.1 | −0.0047 |
| S6 | Aspheric | 5.1335 | 0.1000 | | | | −0.0602 |
| S7 | Aspheric | 5.0690 | 0.4800 | −25.15 | 1.68 | 19.2 | 0.1564 |
| S8 | Aspheric | 3.7567 | 0.5576 | | | | 0.0949 |
| S9 | Aspheric | 4.5579 | 0.5095 | 91.25 | 1.68 | 19.2 | 0.2003 |
| S10 | Aspheric | 4.6990 | 0.7721 | | | | 0.3860 |
| S11 | Aspheric | −55.5937 | 0.8966 | 23.49 | 1.68 | 19.2 | 59.4569 |
| S12 | Aspheric | −12.4454 | 0.6058 | | | | 23.0479 |
| S13 | Aspheric | 10.9740 | 0.4863 | −11.35 | 1.54 | 55.7 | −69.3238 |
| S14 | Aspheric | 3.8562 | 0.1124 | | | | −0.2397 |
| S15 | Spherical | Infinite | 0.2100 | | 1.52 | 64.2 | |
| S16 | Spherical | Infinite | 0.5900 | | | | |
| S17 | Spherical | Infinite | | | | | |

As shown in Table 17, in Embodiment 6, f is a total effective focal length of the optical imaging system, and f is 8.48 mm. TTL is a distance from the object-side surface S1 of the first lens E1 to the imaging surface S17 on the optical axis, and TTL is 9.59 mm. ImgH is a half of a diagonal length of an effective pixel region on the imaging surface S17, and ImgH is 3.39 mm. Semi-FOV is a half of a maximum field of view of the optical imaging system, and Semi-FOV is 20.5°. Explanations about parameters of each relational expression are the same as those in Embodiment 1. Numerical values of each relational expression are listed in the following Table.

TABLE 17
Embodiment 6

| | | | |
|---|---|---|---|
| f(mm) | 8.48 | TTL(mm) | 9.59 |
| ImgH(mm) | 3.39 | Semi-FOV(°) | 20.5 |
| f/EPD | 1.23 | (f1 + R1)/f | 1.37 |
| f2/R3 | −2.48 | f/R4 | 3.44 |
| f3/R5 | 4.00 | (f4 + R8)/f | −2.52 |
| f6/R12 | −1.89 | f7/R14 | −2.94 |
| CT1/CT2 | 4.32 | CT3/CT5 | 2.75 |
| 1/(T45 × T34)(mm⁻²) | 17.93 | TTL/ImgH | 2.83 |

In Embodiment 6, both the object-side surface and the image-side surface of any lens in the first lens E1 to the seventh lens E7 are aspheric surfaces. Table 18 shows high-order coefficients A4, A6, A8, A10, A12, A14, A16, A18, A20, A22, A24, A26, A28 and A30 that can be used for each of the aspheric mirror surfaces S1 to S14 in Embodiment 6.

TABLE 18

| Surface | | | | | | | |
|---|---|---|---|---|---|---|---|
| number | A4 | A6 | A8 | A10 | A12 | A14 | A16 |
| S1 | 2.7160E−01 | 1.4482E−02 | −1.6991E−03 | −1.8396E−03 | −1.2600E−03 | −8.5596E−04 | −4.4597E−04 |
| S2 | 1.5145E−01 | −1.3482E−02 | 1.6918E−03 | −3.0218E−03 | −1.1648E−03 | −3.3500E−04 | −2.9011E−05 |
| S3 | −2.4620E−01 | 5.4240E−04 | 8.2865E−03 | −1.8521E−03 | −2.3465E−03 | −7.4349E−04 | 2.2390E−04 |
| S4 | 1.0801E−01 | 1.2292E−02 | 6.2003E−03 | −1.0077E−03 | −1.0595E−03 | −1.3755E−03 | 6.3455E−05 |
| S5 | 1.2657E−01 | 4.3991E−02 | 7.7785E−03 | −2.0618E−03 | −1.2185E−05 | −7.3305E−04 | −1.2208E−05 |
| S6 | −1.1656E−01 | 1.0876E−02 | −3.8463E−03 | −7.1234E−03 | 6.8525E−04 | 2.2531E−04 | −2.7695E−05 |
| S7 | −8.0589E−02 | −1.2148E−02 | 4.3930E−03 | −2.7962E−03 | −2.1027E−04 | −1.9290E−04 | −2.0033E−04 |
| S8 | 1.2988E−02 | 1.7035E−02 | 1.4725E−02 | 8.0231E−03 | 2.7345E−03 | 1.0792E−03 | 3.4142E−04 |
| S9 | −3.6680E−01 | 1.5849E−02 | 5.0852E−03 | 2.0385E−03 | −4.7787E−04 | −3.1011E−04 | −8.4597E−05 |
| S10 | −3.8582E−01 | 4.9677E−02 | 9.2504E−03 | −2.7407E−03 | −3.6233E−03 | −1.3360E−03 | −4.0676E−05 |
| S11 | −5.6730E−01 | −4.9428E−02 | 1.0019E−02 | 6.6171E−03 | 2.0760E−03 | 4.0869E−04 | −3.5940E−04 |
| S12 | −6.3347E−01 | −1.7602E−02 | 8.7984E−03 | 1.0693E−02 | 5.7235E−03 | 5.3081E−03 | 2.1924E−03 |
| S13 | −1.5510E+00 | 2.0918E−01 | −3.8234E−02 | 4.2515E−02 | 5.6933E−03 | 7.2403E−03 | −3.7218E−03 |
| S14 | −2.5724E+00 | 2.1610E−01 | −1.1939E−01 | 2.7442E−02 | −8.5613E−03 | 9.3895E−03 | −5.3503E−04 |
| Surface | | | | | | | |
| number | A18 | A20 | A22 | A24 | A26 | A28 | A30 |
| S1 | −2.0256E−04 | −3.9489E−05 | −1.3319E−05 | 1.0972E−05 | −8.3436E−08 | 2.6804E−06 | −7.7969E−06 |
| S2 | 1.3518E−05 | 3.6404E−05 | −5.6264E−05 | 6.7824E−06 | −4.9049E−05 | −6.9370E−06 | −2.8174E−05 |
| S3 | −5.0086E−05 | 1.3619E−04 | −3.6316E−05 | 5.0017E−05 | −1.7202E−05 | 8.0812E−06 | −1.0229E−05 |
| S4 | −9.1734E−05 | 1.0871E−04 | 3.0815E−05 | 5.0001E−05 | 1.0896E−05 | 1.4134E−06 | −1.0041E−05 |
| S5 | −1.7046E−04 | −4.5403E−05 | −3.8369E−05 | 3.1649E−06 | −3.8118E−06 | −3.8242E−07 | −1.1217E−05 |
| S6 | −3.7789E−05 | 8.3349E−05 | −5.1641E−06 | 4.1618E−06 | −1.9550E−05 | 6.1233E−06 | −4.0139E−06 |
| S7 | −1.5617E−05 | 1.1024E−04 | 1.1392E−05 | −1.3994E−07 | −1.9103E−05 | 1.9245E−06 | −9.2043E−07 |
| S8 | 1.5992E−04 | 1.0790E−04 | 8.0223E−05 | 4.3383E−05 | 2.2623E−05 | 7.8891E−06 | 4.0846E−06 |
| S9 | 1.7418E−04 | 1.6887E−04 | 1.6109E−04 | 8.3978E−05 | 6.1797E−05 | 2.3617E−05 | 1.7832E−05 |
| S10 | 3.1689E−04 | 1.8866E−04 | 1.2472E−05 | −8.5564E−05 | −7.9919E−05 | −4.7393E−05 | −1.2844E−05 |
| S11 | −5.5244E−04 | −3.1565E−04 | −8.7256E−05 | 7.1800E−05 | 7.7487E−05 | 5.2200E−05 | 1.5218E−05 |
| S12 | 9.1483E−04 | 2.3297E−04 | 5.9530E−05 | 3.8236E−07 | −1.6395E−05 | −4.2728E−06 | −2.8601E−06 |
| S13 | −1.8513E−03 | −7.4817E−04 | 2.9273E−04 | 1.0290E−04 | 5.9772E−05 | −1.6488E−05 | 9.9052E−06 |
| S14 | 1.6985E−03 | 1.0943E−04 | 6.6885E−04 | 1.5612E−04 | 2.3046E−04 | 1.2251E−05 | −7.1806E−06 |

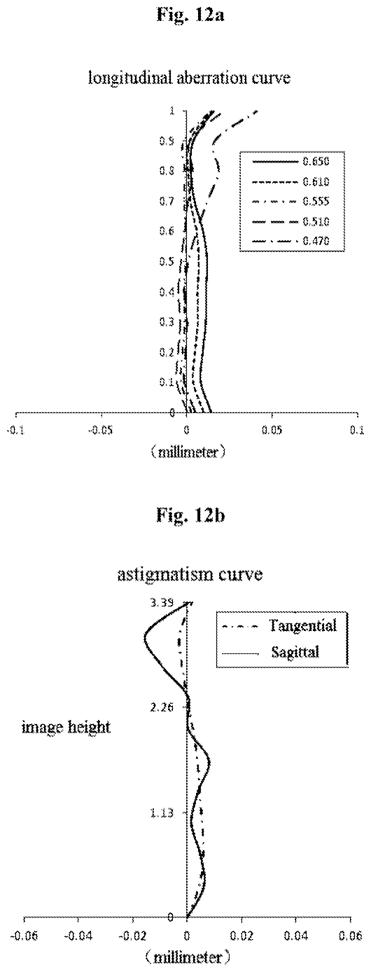

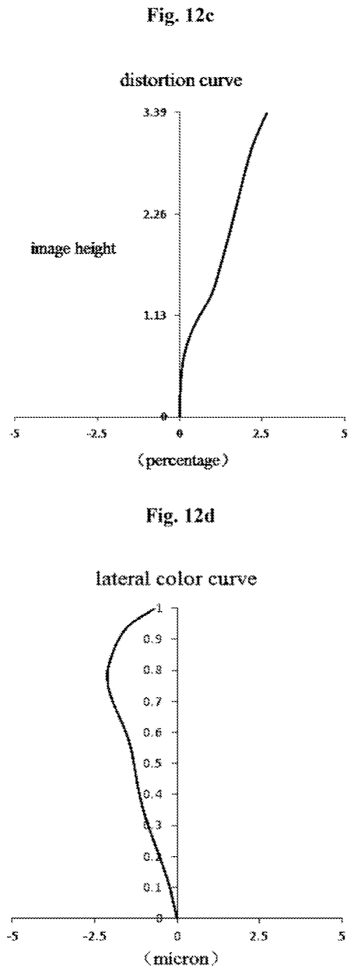

FIG. 12a shows a longitudinal aberration curve of the optical imaging system according to Embodiment 6 to represent deviations of a convergence focal point after lights with different wavelengths pass through the lens. FIG. 12b shows an astigmatism curve of the optical imaging system according to Embodiment 6 to represent a tangential image surface curvature and a sagittal image surface curvature. FIG. 12c shows a distortion curve of the optical imaging system according to Embodiment 6 to represent distortion values corresponding to different image heights. FIG. 12d shows a lateral color curve of the optical imaging system according to Embodiment 6 to represent deviations of different image heights on the imaging surface after the light passes through the lens. According to FIGS. 12a-12d, it can be seen that the optical imaging system provided in Embodiment 6 may achieve high imaging quality.

The above are only specific embodiments of the disclosure and are not intended to limit the disclosure. Any modifications, improvements, equivalent replacements and the like made within the spirit and principle of the disclosure shall fall within the scope of protection of the disclosure.

What is claimed is:

1. An optical imaging system, sequentially comprising from an object side to an image side along an optical axis:
a diaphragm;
a first lens with a refractive power;
a second lens with a negative refractive power;
a third lens with a refractive power;
a fourth lens with a negative refractive power;
a fifth lens with a refractive power;
a sixth lens with a positive refractive power, an image-side surface thereof is a convex surface; and
a seventh lens with a refractive power;
wherein an effective focal length f of the optical imaging system and an entrance pupil diameter (EPD) of the optical imaging system satisfy: f/EPD<1.4.

2. The optical imaging system according to claim 1, wherein an effective focal length f1 of the first lens, a curvature radius R1 of an object-side surface of the first lens and the effective focal length f of the optical imaging system satisfy: 1.0<(f1+R1)/f<1.6.

3. The optical imaging system according to claim 1, wherein an effective focal length f2 of the second lens and a curvature radius R3 of an object-side surface of the second lens satisfy: −6.5<f2/R3<−2.0.

4. The optical imaging system according to claim 1, wherein the effective focal length f of the optical imaging system and a curvature radius R4 of an image-side surface of the second lens satisfy: 2.5<f/R4≤3.5.

5. The optical imaging system according to claim 1, wherein an effective focal length f3 of the third lens and a curvature radius R5 of an object-side surface of the third lens satisfy: 1.5<f3/R5<5.0.

6. The optical imaging system according to claim 1, wherein an effective focal length f4 of the fourth lens, a curvature radius R8 of an image-side surface of the fourth lens and the effective focal length f of the optical imaging system satisfy: −3.0<(f4+R8)/f<0.

7. The optical imaging system according to claim 1, wherein an effective focal length f6 of the sixth lens and a curvature radius R12 of the image-side surface of the sixth lens satisfy: −2.0<f6/R12<0.

8. The optical imaging system according to claim 1, wherein an effective focal length f7 of the seventh lens and a curvature radius R14 of an image-side surface of the seventh lens satisfy: −9.5<f7/R14<−2.5.

9. The optical imaging system according to claim 1, wherein a center thickness CT1 of the first lens on the optical axis and a center thickness CT2 of the second lens on the optical axis satisfy: 3.5<CT1/CT2<5.0.

10. The optical imaging system according to claim 1, wherein a center thickness CT3 of the third lens on the optical axis and a center thickness CT5 of the fifth lens on the optical axis satisfy: 2.0<CT3/CT5<3.5.

11. The optical imaging system according to claim 1, wherein T45 is an air space between the fourth lens and the fifth lens on the optical axis, T34 is an air space between the third lens and the fourth lens on the optical axis, and T45 and T34 satisfy: 17.0 mm⁻²<1/(T45×T34)<27.0 mm⁻².

12. The optical imaging system according to claim 1, wherein Semi-FOV is a half of a maximum field of view of the optical imaging system, and Semi-FOV satisfies: 10.0°<Semi-FOV<30.0°.

13. The optical imaging system according to claim 1, wherein TTL is an on-axis distance from an object-side surface of the first lens to an imaging surface, ImgH is a half of a diagonal length of an effective pixel region on the imaging surface, and TTL and ImgH satisfy: 2.5<TTL/ImgH<3.0.

14. An optical imaging system, sequentially comprising from an object side to an image side along an optical axis:
a diaphragm;
a first lens with a refractive power;
a second lens with a negative refractive power;
a third lens with a refractive power;
a fourth lens with a negative refractive power;
a fifth lens with a refractive power;
a sixth lens with a positive refractive power, an image-side surface thereof is a convex surface; and
a seventh lens with a refractive power,
wherein an effective focal length f of the optical imaging system and a curvature radius R4 of an image-side surface of the second lens satisfy: 2.5<f/R4≤3.5.

15. The optical imaging system according to claim 14, wherein the effective focal length f of the optical imaging system and an entrance pupil diameter (EPD) of the optical imaging system satisfy: f/EPD<1.4.

16. The optical imaging system according to claim 14, wherein an effective focal length f1 of the first lens, a curvature radius R1 of an object-side surface of the first lens and the effective focal length f of the optical imaging system satisfy: 1.0<(f1+R1)/f<1.6.

17. The optical imaging system according to claim 14, wherein an effective focal length f2 of the second lens and a curvature radius R3 of an object-side surface of the second lens satisfy: −6.5<f2/R3<−2.0.

18. The optical imaging system according to claim 14, wherein an effective focal length f3 of the third lens and a curvature radius R5 of an object-side surface of the third lens satisfy: 1.5<f3/R5<5.0.

19. The optical imaging system according to claim 14, wherein an effective focal length f4 of the fourth lens, a curvature radius R8 of an image-side surface of the fourth lens and the effective focal length f of the optical imaging system satisfy: −3.0<(f4+R8)/f<0.

20. The optical imaging system according to claim 14, wherein an effective focal length f6 of the sixth lens and a curvature radius R12 of the image-side surface of the sixth lens satisfy: −2.0<f6/R12<0.
